(19) United States
(12) Patent Application Publication
(10) Pub. No.: US 2021/0407266 A1
(43) Pub. Date: Dec. 30, 2021

(54) REMOTE SECURITY SYSTEM AND METHOD

(71) Applicant: AI Data Innovation Corporation, Bellevue, WA (US)

(72) Inventors: Patrick McKinley JARVIS, Redmond, WA (US); Ke WANG, Charlottesville, VA (US)

(21) Appl. No.: 17/356,867

(22) Filed: Jun. 24, 2021

Related U.S. Application Data
(60) Provisional application No. 63/043,649, filed on Jun. 24, 2020.
(60) Provisional application No. 63/139,099, filed on Jan. 19, 2021.

(51) Int. Cl. G08B 13/196; G06K 9/00; G06T 7/20; G06F 21/62; G07C 9/38; G06N 3/02

(52) U.S. Cl. CPC G08B 13/19613; G08B 13/19608; G06K 9/00771; G06K 9/00288; G06T 2207/30232; G06F 21/6254; G07C 9/38; G06N 3/02; G06T 2207/10016; G06T 7/20

(57) ABSTRACT

A remote security system and method for securing a workstation including a display within a space may comprise at least one image capture device, at least one lock mechanism configured to cooperate with an entrance to the space, and at least one network access security device configured to cooperate with the workstation. The system may comprise internal components configured to cooperate with external components including a processor configured to determine from a captured image the presence of an unauthorized person, device, or activity. The captured image may be processed and annotated using an artificial intelligence modality.

### RELATED APPLICATIONS

This application claims priority to and the benefit of U.S. provisional patent application Ser. No. 63/043,649, filed Jun. 24, 2020, and U.S. provisional patent application Ser. No. 63/139,099, filed Jan. 19, 2021, both of which are incorporated herein by reference in their entireties.

### TECHNICAL FIELD

The disclosure relates to a remote security system and method for allowing employees to securely work from home and/or to securely handle sensitive information.

### BACKGROUND

With the unprecedented effects of the COVID-19 pandemic across the world, millions of employees have been obliged to work remotely from their homes to implement social-distancing measures so as to slow the spread of the novel coronavirus. It is estimated that whereas prior to the COVID-19 pandemic less than 10% of the U.S. workforce (comprising some 140 million civilian employees) had the option to work from home, over 50% of the U.S. workforce has jobs that are compatible with remote work, and some 90% of organizations have encouraged or required employees to work from home. Additionally, it is estimated that approximately 25-30% of the U.S. workforce will be working remotely multiple days per week by the end of 2021, with a larger-scale transition to working from home (“WFH”) precipitated by effects of the COVID-19 pandemic.

On-site work environments advantageously allow an employer to take measures to provide a secure working environment where sensitive information such as personally identifiable information (“PII”), work product, and processes can be monitored and protected. This can include requiring that employees “badge-in” to restricted areas or facilities using identification credentials such as a smart card, biometric identification such as facial-recognition modalities, keypads, or otherwise, providing locked offices and “clean rooms” where outside devices are restricted or monitored, providing cameras and surveillance systems, providing in-person supervision, providing network-access control measures, and using other measures such as centralized monitoring. Among other benefits, these measures can help an employer to ensure that privacy and other information-security laws or regulations, such as the General Data Protection Regulation (“GDPR”) are not violated, and that proprietary and/or sensitive information is protected.

The transition of many or all employees of many companies and firms to WFH arrangements through the course of the COVID-19 pandemic, and the predicted larger-scale transition to WFH generally, presents numerous challenges to employers regarding the security of proprietary and/or sensitive information and adhering to privacy and information-security laws, as the standard measures for securing a work environment are not present at each employee's home. Employers have few options for effectively managing who has access to sensitive information on employees' workstations when the employees work from their home, a third location such as a coffee shop, or a shared workspace. In particular, employers are largely unable to control physical access, i.e., who can enter a room where the employee and workstation are located and what devices can be present in the workspace when sensitive or confidential material is being handled, and respond accordingly.

Many employers have provided virtual private networks (VPNs) to facilitate secure transmission of information across public networks and have required compliance with strict email protocol and secure home Wi-Fi systems, while conceding that traditional physical perimeter security solutions are in many cases no longer effective. In the absence of more effective measures for controlling access to proprietary information (such as information at risk of being viewed by an unauthorized third person in the vicinity of an employee workstation) and controlling physical access to employee workstations, numerous employers have resorted to educating employees about information-security concerns and simply encouraging employees to lock the doors and windows to their home offices and to exercise caution when viewing or working with sensitive information.

Existing approaches also lack a customizable method or system for applying a secure remote home office space that complies with legal requirements of the jurisdiction in which the remote home office space and a corresponding central server are located, particularly regarding the transmission of information between the remote home office space and the central server.

In view of the deficiencies of existing modalities for securing a home office, there is a need for a remote security system and method that provides robust and certifiable compliance with information-security and proprietary information requirements. There is also a need for a remote security system that can be adapted to home offices of different sizes and types in a cost-effective manner.

### SUMMARY

A remote security system and method according to embodiments of the present disclosure advantageously provides for certifiable and robust security in a home office or other remote setting for an employee in a cost-effective manner to mitigate the challenges of securing proprietary or sensitive information and ensuring compliance for remote and/or WFH employees. The remote security system and method embodiments advantageously provide hardware, software, centralized monitoring modalities, and procedures that can be adapted to an employee user's home office or other remote work setting and together synergistically ensure proper handling of sensitive information and legal compliance by effectively and securely separating a user's remote office space from a remainder of the user's home or another location.

In embodiments, the remote security system may comprise or cooperate with one or more subsystems configured to synergistically cooperate with each other to secure a space for compliance with employer and/or regulatory requirements. The remote security system may comprise, in embodiments, one or more of a sensing subsystem, a control subsystem, a processing subsystem, a storage subsystem, a human monitoring subsystem, a human User Interface (UI) subsystem and a communication subsystem. The communication subsystem may facilitate cooperation between, for example exchange of data, one or more of the sensing, control, processing, storage, and human monitoring subsystems. In addition, the communication subsystem may include an interface into other existing security systems that will allow the existing security systems to use one or more of the sensing subsystem, the control subsystem, the processing subsystem, the storage subsystem, the human monitoring subsystem, and/or the human User Interface (UI) subsystem of the remote security system disclosed herein.

In embodiments, a sensing subsystem of the remote security system may comprise at least one image capture device configured to capture an image or video of a space, such as a workspace including a home office. The image capture device may be arranged proximate an entrance to the space to provide information through a communication subsystem that can be used to activate at least one lock mechanism of a human monitoring subsystem. The lock mechanism may cooperate with the entrance to the space, such as a conventional door in a home, to restrict entry to the space, as necessary.

For example, as the image capture device captures an image of a person attempting to gain entry to the space, the remote security system may determine from the image that the person is an authorized person and actuate the lock mechanism to unlock and permit entry. By contrast, the system may instruct the lock mechanism to remain locked if the person is not determined to be an authorized person. The lock mechanism and/or the image capture device can be provided as modular components configured for wireless or wired connectivity and either direct power or battery power, advantageously facilitating simple and/or flexible installation in any suitable location, such as the specific room of a user's home where the work will be performed.

The sensing subsystem of the remote security system may comprise a second image capture device located inside the space and configured to face a workstation, such as a user's desktop or laptop computer, desk, or otherwise. The second image capture device may be configured to provide information to the system regarding the presence of authorized persons and/or the user's activities, such as the presence of restricted devices, the type of activity being conducted, or the information being displayed on a display of the workstation.

The human monitoring subsystem of the remote security system may comprise a network access security device configured to cooperate with the user's workstation. The network access security device may be configured to deactivate a display, a processing unit, or both of the workstation based on information obtained from the first and/or second image capture devices.

For example, if an unauthorized person's presence is detected, an alarm may be sounded, and the network access security device may automatically deactivate the display to prevent sensitive information from being accessed by the unauthorized person. In other embodiments, if an unauthorized person's presence is detected, the network access security device may deactivate or lock the processing unit of the workstation to prevent access to a network or modifications to work products.

The network access security device may be configured to be compatible with a variety of different workstations hosting different operating systems and connection modalities, such as wireless or wired connection and direct power or battery power. In this manner, the network access security device may be configured for facilitating simple installation in an existing or new home office.

The human monitoring subsystem of the remote security system may further comprise a central server configured to communicate through a communication subsystem with one or more of the first and second image capture devices, the lock mechanism, and/or the network access security device to determine the presence of an authorized person. The central server may comprise or cooperate with a storage subsystem of the remote security system comprising a central database. The central database may comprise information regarding authorized persons and/or information obtained, for example, from the sensing subsystem, such as image data generated by the at least one image capture device. Information on stored on the central database may be maintained according to a standard protocol, such as for a predefined period of, say, 90 days or any other suitable length of time.

The central database may comprise and/or compile event information regarding entries into, exits from, and activities performed within the space. The central server may coordinate activities in multiple spaces comprising respective remote security systems, for example for a plurality of employees of a same employer and/or for a plurality of employees of different employers, which may be located in a same locale or across the globe.

The central server may also be part of or cooperate with a processing subsystem, the processing subsystem comprising or cooperating with one or more processors located remote from the remote security system or local thereto. The one or more processors may be configured to apply one or more artificial intelligence modules to the captured images. The images from the image capture devices may be analyzed using a facial recognition module, for example. The one or more processors may be configured to receive through the communication subsystem an identification credential from the remote security system, obtained for example through the lock mechanism, and authenticate the identification credential using the central database.

In embodiments, the identification credential may be a password, a passcode, an identification card, a biometric identification credential such as a fingerprint or retina scan, combinations thereof, or otherwise. The central processor may compare the obtained identification credential against predetermined identification credentials stored in the central database to authenticate the identification credential and send an authentication signal to the remote system. While the remote security solution has been described as performing processing on a processor located at the central server, it will nevertheless be appreciated that the processor and/or database may be provided locally, such as on the network access security device.

The human monitoring subsystem of the remote security system may further comprise signage configured to be removably attached proximate the entrance of the space, the signage comprising indicia regarding authorized persons and the sensitivity of the information in the space. The signage may be configured to be attached on the entrance to the space, such as on an outer surface of a door. The signage may comprise or cooperate with one or more suitable attachment components, including adhesives, hardware, magnets, or otherwise.

The human monitoring subsystem of the remote security system may further comprise one or more glare screens configured to be removably attached to a display of the workstation to prevent unauthorized persons from viewing sensitive material displayed thereon. The image capture device may be configured to capture images for determining whether the one or more glare screens are properly secured before, or as sensitive information is displayed on the workstation.

The images obtained from the image capture device may be processed by the processing subsystem at the central server or locally using a suitable image processing modality, such as an artificial intelligence modality. The remote security system may be configured to allow for a captured image or video to be transmitted from the workstation to the central server as raw image or video, as an AI-annotated image or video, or as AI-annotation only without the underlying image or video. The image or video may also be transmittable by the communication subsystem along distinct channels corresponding to raw image or video, AI-annotated image or video, and AI-annotation only, respectively.

The human UI subsystem may comprise or cooperate with one or more components or methods for allowing a human user of the remote security system to communicate with the system through the communication subsystem in response to an alarm or other action generated by the control subsystem and/or the human monitoring subsystem. In embodiments, the human UI subsystem may comprise a computing device such as laptop, a tablet computer, a mobile device, or a dedicated pager with one or more buttons or other user interface elements that allow for user input. The human UI subsystem may also comprise an app on the mobile device or a QR code that is scannable by the mobile device. Upon receipt of an alarm or other action taken by one or more of the other subsystems in response to the detection of an unauthorized occupant or item, a human user is able to use the one or more buttons or other user interface elements to input acknowledgement of the alarm or other action and also to input that remedial action, such as removal of the unauthorized person or object, has been performed. This is communicated through the communication subsystem to the control subsystem and/or the human monitoring subsystem so that the alarm or other action taken by one or more of the other subsystems in response to the detection of an unauthorized occupant or item may be dismissed.

### BRIEF DESCRIPTION OF THE DRAWINGS

These and other features, aspects, and advantages of the present disclosure will become better understood regarding the following description, appended claims, and accompanying drawings.

FIG. 1A is a diagram of a remote security system according to an embodiment of the disclosure.

FIG. 1B is a perspective view of a remote security system according to an embodiment.

FIG. 1C is an alternative view of the remote security system of FIG. 1A.

FIG. 2 is a diagram of a remote security method according to an embodiment.

FIG. 3 is a diagram of a remote security system according to embodiments.

FIG. 4A is a diagram of a remote security system according to an embodiment.

FIG. 4B is a perspective view of a remote security system according to the embodiment of FIG. 4A.

FIG. 5 is a simplified diagram of a processor portion of a remote security system according to the embodiment of FIG. 4A.

FIG. 6 is a simplified diagram of an AI engine of the processor portion of FIG. 5.

FIG. 7 is a simplified diagram of a remote security management system according to an embodiment.

FIG. 8 is a simplified diagram of the remote security management system according to the embodiment of FIG. 7.

FIG. 9 is a simplified diagram of a user interface for use with a remote security system according to the embodiment of FIG. 4A.

FIG. 10 is a schematic view of an AI-annotated frame of a video according to an embodiment.

FIG. 11 is a diagram of a remote security method according to an embodiment.

### DETAILED DESCRIPTION OF VARIOUS EMBODIMENTS

### A. Overview

A better understanding of different embodiments of the disclosure may be had from the following description read with the accompanying drawings in which like reference characters refer to like elements.

While the disclosure is susceptible to various modifications and alternative constructions, certain illustrative embodiments are in the drawings and are described below. It should be understood, however, there is no intention to limit the disclosure to the specific embodiments disclosed, but on the contrary, the intention covers all modifications, alternative constructions, combinations, and equivalents falling within the spirit and scope of the disclosure.

It will be understood that unless a term is expressly defined in this application to possess a described meaning, there is no intent to limit the meaning of such term, either expressly or indirectly, beyond its plain or ordinary meaning.

The flowchart illustrations and block diagrams in the flow diagrams illustrate the architecture, functionality, and operation of possible implementations of systems, methods, and computer program products according to various embodiments of the present disclosure. In this regard, each block in the flowchart illustrations or block diagrams may represent a module, segment, or portion of code, which comprises one or more executable instructions for implementing the specified logical function(s).

It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart illustrations and/or block diagram block or blocks.

### B. Various Embodiments and Components for Use Therewith

Remote security system and method embodiments are described herein. The remote security system and method embodiments may make use of any suitable component in any suitable way and/or configuration for providing improved security in remote work settings.

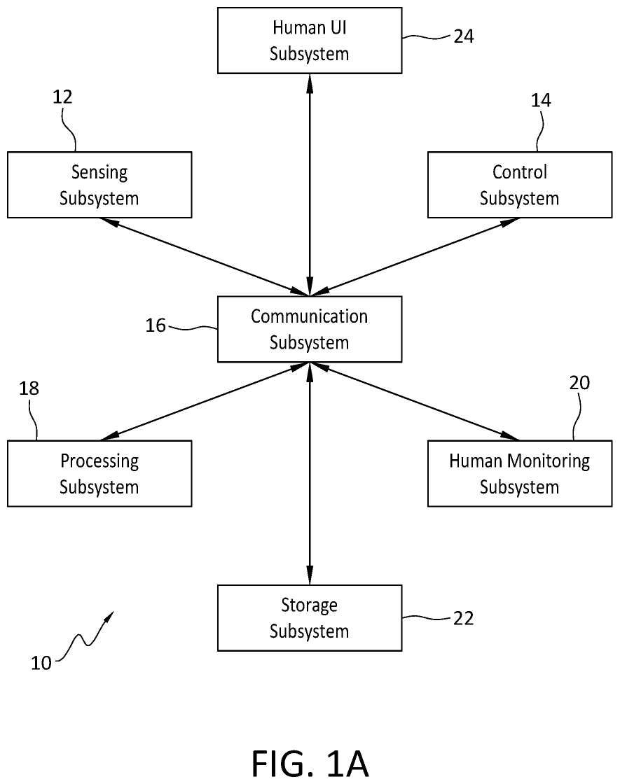

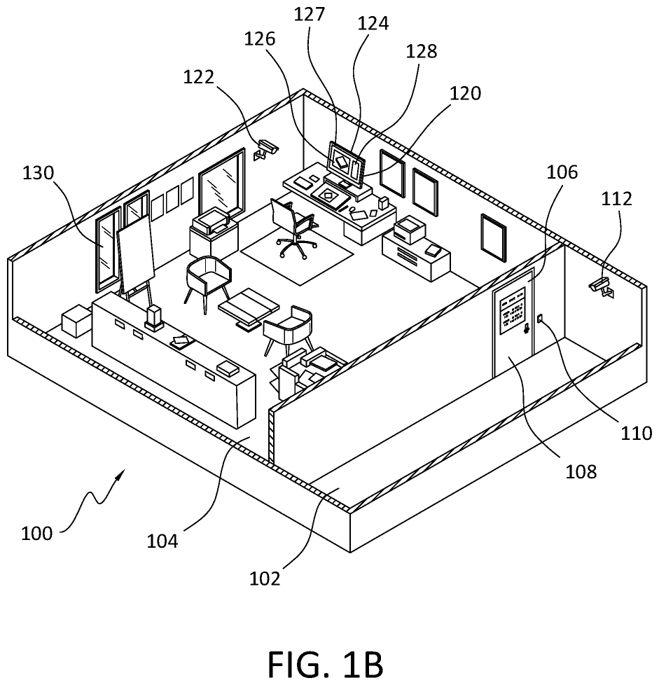

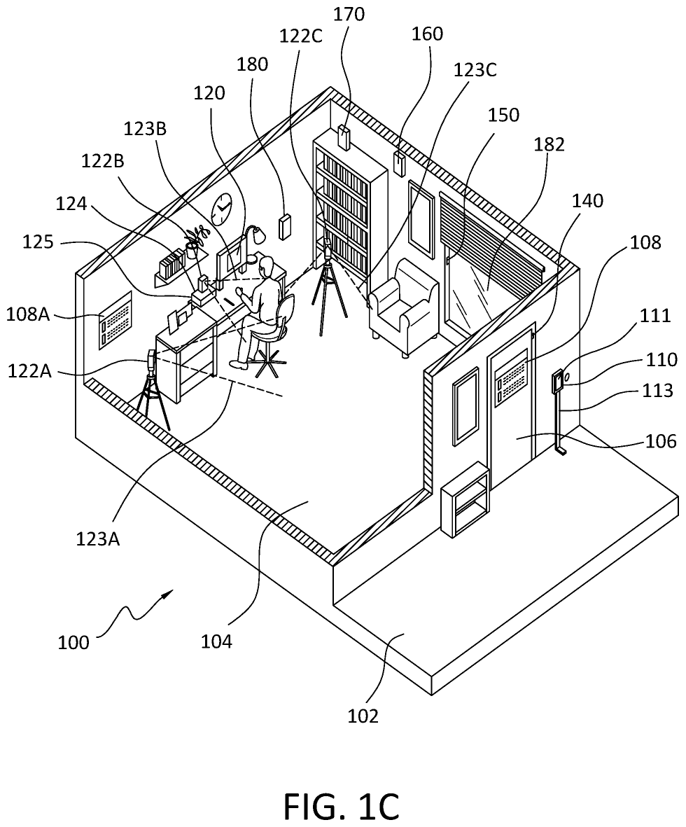

FIG. 1A shows a diagram of a remote security system 10 according to an embodiment of the present disclosure. The remote security system 10 may comprise or cooperate with one or more subsystems to carry out the functions described herein. For example, the remote security system 10 may comprise or cooperate with a sensing subsystem 12, a control subsystem 14, a communication subsystem 16, a processing subsystem 18, a human monitoring subsystem 20, a storage subsystem 22, and/or a human User Interface (UI) subsystem 24. The communication subsystem 16 may link one or more of the other subsystems 12, 14, 18, 20, 22, 24 to one or more of the other subsystems as suitable.

The communication subsystem 16 may receive data from the sensing subsystem 12, captured for example using an image capture device or other sensor, and transmit the same to a control subsystem 14, a processing subsystem 18, and/or a storage subsystem 22 for automatic determination of whether an unauthorized person, object or activity is present or taking place in a secure workspace. Upon determination of an alarm or authorization, the communication subsystem 16 may transmit an alarm signal or authorization signal, as will be described in greater detail herein, to the human monitoring subsystem 20. For example, in some embodiments a person or an object or device such as a mobile phone may not be authorized to be in the secure workspace and so the alarm may be triggered. However, in some embodiments the person or the object may be authorized to be in the secure workspace, but may not be authorized to perform certain activities. For instance, an authorized person may be authorized to have a mobile phone in the secure workspace, but may not be authorized to take any pictures with the mobile phone. If the authorized person is detected taking pictures with the authorized mobile phone, the unauthorized activity of taking the pictures may cause the alarm to be triggered.

After the communication subsystem 16 transmits image data captured by the sensing subsystem 12 to the processing subsystem 18, the storage subsystem 22, and/or the control subsystem 14, an alarm signal may be generated by the control subsystem 14. The alarm signal may be transmitted by the communication subsystem 16 to the human monitoring subsystem 20 such that a component of the remote security system 10, such as a door lock or a network access security device, may be appropriately activated to prevent access to secure or sensitive information by unauthorized persons. Alternatively, the control subsystem 14 may automatically cause the component of the remote security system 10 to be activated to prevent access to secure or sensitive information by unauthorized persons. It will be appreciated that one or more of the subsystems 12, 14, 16, 18, 20, 22, 24 of the remote security system 10 may be omitted in an implementation or used in an alternative manner. It will also be appreciated that communication between the communication subsystem 16 and any one of the other subsystems 12, 14, 18, 20, 22, 24 may be two-way.

The communication subsystem 16 may comprise or cooperate with any suitable modality for receiving, storing, and/or transmitting information from one or more of the subsystems of the remote security system. For example, the communication subsystem 16 may comprise a wireless communication modality, such as a wireless router, a wired communication modality, such as a local area network connection, or any other suitable modality. The communication subsystem 16 may communicate with different subsystems in different manners as suitable. In addition, the communication subsystem may include an interface into other existing security systems that will allow the existing security systems to use one or more of the sensing subsystem, the control subsystem, the processing subsystem, the storage subsystem, the human monitoring subsystem, and/or the human User Interface (UI) subsystem of the remote security system disclosed herein.

The processing subsystem 18 may comprise or cooperate with any suitable processing modality. The processing modality may be any suitable processor, as will be discussed here below. In embodiments, the processor is local to the remote security system 10. In other embodiments, the processor is remote from the remote security system 10. The processing subsystem 18 may be distributed over multiple locations, for example local to a secured workspace 104 or part of a central server. In embodiments, information generated by components of the remote security system 10 is processed using a cloud computing modality. Combinations of the foregoing may be utilized. Any suitable modality may be used for processing and transforming the information obtained from and using the remote security system 10.

The storage subsystem 22 may comprise or cooperate with any suitable modality for receiving, compiling, storing, and otherwise handling information obtained from or using the remote security system 10. The storage subsystem 22 may further store and/or transmit information pertaining to one or more remote security systems 10 and/or authorized users thereof. For example, the storage subsystem 22 may contain identification credentials for one or more authorized users of a remote security system, allowing the remote security solution to authenticate a user by comparing information obtained using the sensing subsystem 12 against the stored credentials. The identification credentials or other information pertaining to the remote security system 10 may be transmitted to the storage subsystem 22 in substantially real-time or may be pre-supplied by an employer or organization.

The storage subsystem 22 may comprise one or more data storage modalities, including but not limited to primary storage, such as random access memory (RAM), secondary storage, such as hard disk drives and solid-state drives, external hard disk and/or solid-state drives, flash memory devices, offline storage, cloud storage, combinations thereof, or any other suitable data-storage device or method. The storage subsystem 22 may be configured to store the information for any suitable length of time, up to indefinitely.

The sensing subsystem 12 may comprise or cooperate with any suitable sensing element or method. In embodiments, the sensing system 12 comprises one or more of an image capture device, a door sensor, a window sensor, a motion sensor, a microphone, suitable Internet of Things (IoT) sensors, combinations thereof, or otherwise. The sensing subsystem 12 may comprise or cooperate with any device or method for obtaining information about a user and/or a workspace, including information about an environment in or surrounding the workspace. The individual components of the sensing system 12 may be connected to each other and/or directly to the communication subsystem 16.

The human monitoring subsystem 20 may comprise or cooperate with one or more components or methods for facilitating monitoring of a secure workspace, reviewing automated decisions, and/or unlocking/restoring a remote security system after an event, such as after the system automatically locks the system in response to an alarm signal. In embodiments, the human monitoring subsystem 20 comprises a computing device, such as a laptop, mobile device, server, or otherwise, that may be utilized by a Security Operations Center (SOC) pertaining to a particular employer or organization. The SOC may facilitate automatic or manual review by a reviewer or SOC supervisor of individual events detected in the workspace, data generated or received by one or more components of the sensing subsystem 12, and/or signals generated or received by one or more of the processing, control, and/or storage subsystems. In some embodiments, the human monitoring subsystem may be part of or cooperate with the processing subsystem 18.

The control subsystem 14 may comprise or cooperate with one or more components configured for securing a workspace in response to one or more conditions or signals. For example, the control subsystem 14 may comprise one or more actuators configured to unlock or lock a door to the workspace, activate or deactivate a workstation, cut power to the workstation or other components, or any other suitable action. Upon receiving an alarm signal through the communication subsystem 16, the control subsystem 14 may advantageously lock the door, deactivate a workstation, deactivate a monitor of the workstation, cut off network access by or to the workstation, switch off any lights inside the workstation, and/or any other suitable action. Upon receiving an authorized entry signal, the control subsystem 14 may unlock a door, activate a workstation, and/or permit network access. Any suitable type, number, and combination of actions may be performed by the control subsystem 14.

The human UI subsystem 24 may comprise or cooperate with one or more components or methods for allowing a human user of the remote security system 10 to communicate with the system through the communication subsystem 16 in response to an alarm or other action generated by the control subsystem 14 and/or the human monitoring subsystem 20. In embodiments, the human UI subsystem 24 may comprise a computing device such as laptop, a tablet computer, a mobile device, or a dedicated pager with one or more buttons or other user interface elements that allow for user input. The human UI subsystem 24 may also comprise an app on the mobile device or a QR code that is scannable by the mobile device. Upon receipt of an alarm or other action taken by one or more of the other subsystems in response to the detection of an unauthorized occupant or item, a human user is able to use the one or more buttons or other user interface elements to input acknowledgement of the alarm or other action and also to input that remedial action, such as removal of the unauthorized person or object, has been performed. This is communicated through the communication subsystem 16 to the control subsystem 14 and/or the human monitoring subsystem 20 so that the alarm or other action taken by one or more of the other subsystems in response to the detection of an unauthorized occupant or item may be ended.

In some embodiments, the human UI subsystem 24 may also function as the recipient of the alarm or other action taken by one or more of the other subsystems in response to the detection of an unauthorized occupant or item. For example, in some embodiments it may not be possible to have an alarm that sounds, or flashes as will be described to follow in response to the unauthorized actions. In such embodiments the human UI subsystem 24 may act to receive a notification using the UI elements of the human UI subsystem 24 that functions as an alarm. For example, the human UI subsystem 24 may receive a notification that an unauthorized device is present, and this notice may be in the form of an audio or visual output using the built-in UI elements of the human UI subsystem 24. The human user is then able to correct the problem such as removing the unauthorized device and use the UI elements of the human UI subsystem 24 to communicate this with the other subsystems of the remote security system 10 as described.

Turning to FIG. 1B, a remote security system 100, which may correspond to the remote security system 10, according to an embodiment is shown in perspective view. The remote security system 100 may comprise components extending across an exterior space 102 and a securable or secured space, such as a workspace 104. The remote security system 100 may comprise one or more components as described herein to effectively secure the workspace 104 from the exterior space 102. For example, the exterior space 102 may be a main living area of a user or employee's home separate from a home office or room which is used at times as a dedicated workspace 104.

The workspace 104 may be separated from the exterior space 102 by an entrance 106 such as a door. A control subsystem of the remote security system 100 may comprise at least one locking mechanism 110 configured to prevent entry into or exit out of the workspace 104 when in a locked condition, and to permit entry and exit when in an unlocked condition. The at least one locking mechanism 110 may be any suitable locking modality such as an electric solenoid bolt, an electric drop bolt, a magnetic lock, or otherwise. In embodiments, the at least one locking mechanism 110 may be actuated automatically by the remote security system 100. The at least one locking mechanism 110 may be configured for wired or wireless communication with the components of the system 100.

The remote security system 100 may comprise a sensing subsystem comprising, for example, an identification module configured to receive at least one identification credential. The at least one identification credential may be any suitable identification credential, including biometric identification credentials such as fingerprint scans, retina identification, voice recognition, facial recognition, or otherwise, physical identification credentials such as a smart card, passcodes, combinations thereof, or any other suitable identification credential.

In embodiments, the identification module is configured to require that a user provides one or more, preferably two or more, in certain embodiments three or more identification credentials in order to gain entry to the workspace 104. For example, a user may be required to successfully provide an authorized smart code, corresponding passcode, and voice recognition credential in order to enter. Any suitable number and combination of identification credentials is contemplated.

The at least one locking mechanism 110 may be connected to components of the remote security system 100 in any suitable manner, including wired or wireless connections such as Wi-Fi and Bluetooth, which may correspond to the communication subsystem (i.e., communication subsystem 16) of the remote security system 100. The locking mechanism 110 may transmit the one or more received identification credential through a communication subsystem to a control subsystem, a processing subsystem, and/or storage subsystem, such as a central server (described further below), for authenticating the received identification credential.

The central server may comprise or cooperate with a control subsystem and/or a processing subsystem and may compare the identification credential against a central database of a storage subsystem accessed by or cooperating with the central server to authenticate a person as being authorized. Upon authenticating the identification credential, the central server may transmit an authentication notification or signal using the communication subsystem to the locking mechanism 110 of the control subsystem to automatically actuate the locking mechanism 110 from a default locked configuration to an unlocked configuration, permitting entry into the workspace 104. Additionally, or alternatively, the central server may transmit the authentication notification to a network access security device of the control subsystem to activate or allow activation of a workstation, to permit activation of a monitor of the workstation, to provide power to the workstation, to provide light in the workspace, or otherwise. In embodiments, the identification credential may be authenticated locally rather than by the central server.

The locking mechanism 110 may be configured to be actuated to the unlocked configuration for a predetermined amount of time upon authentication of the identification credential. In embodiments, the predetermined amount of time may be one minute, 30 seconds, 15 seconds, five seconds, or otherwise.

The sensing subsystem of the remote security system 100 may further comprise at least one image capture device 112 configured to capture an image or a video of at least part of the workspace 104 and/or the exterior space 102. As seen in FIG. 1, the image capture device 112 is a digital camera configured to be removably attached in the exterior space 102 and facing the entrance 106 so as to capture an image of a person entering or exiting, or attempting to exit or enter, the workspace 104. The camera 112 may be any suitable camera, such as one or more of a box camera, a dome camera, a pan, tilt, and zoom (PTZ) camera, a bullet camera, a wired or wireless Internet Protocol (IP) camera, a thermal security camera, or any other suitable camera.

The camera 112 may capture an image or video of the entrance 106 to detect any unauthorized entry or exit. The camera 112 may be automatically activated upon authentication of the identification credential and subsequent unlocking of the locking mechanism 110, with the image or video of the authenticated user entering the workspace 104 captured to ensure that additional persons do not enter the workspace 104 with the authorized user. In embodiments, the camera 112 may also be utilized to capture image or video for carrying out facial recognition, retina recognition, or other biometric identification as described herein. In embodiments, the camera 112 is configured to capture at least one image of a person at the entrance 106 for authentication in conjunction with the identification module of the lock mechanism 110 such that the entrance 106 is unlocked after, for instance, at least one biometric identification credential has been received and a facial-recognition procedure has been successfully conducted using the camera 112.

The control subsystem of the remote security system 100 may comprise at least one signage element 108 configured to be removably attached to or proximate the entrance 106. The signage element 108 may comprise any suitable indicia for designating the workspace 104 as a secure office environment, listing authorized persons, providing instructions for presenting required identification credentials to the locking mechanism 110, providing pertinent legal notices, or otherwise. Any suitable attachment component may be used, including adhesives, hardware, magnets, or otherwise.

The control subsystem of the remote security system 100 may comprise at least one alarm component (not shown) configured to cooperate with the locking mechanism 110 and other components as discussed herein. The alarm component may be activated by the system 100 upon detection that an unauthorized person has entered the workspace 104 through the entrance 106. For example, upon detection by system 100 from the images obtained using the camera 112 that an unauthorized person has entered the workspace 104 (such as by “piggybacking” on an authorized user during the predetermined amount of time during which the locking mechanism 110 is in the unlocked configuration following a successful authentication or entering through the entrance 106 in lieu of the authorized person), the alarm component may be activated. The system 100 may detect that the entrance 106 has opened using a sensor embedded in the lock mechanism 110 and/or using the camera 112. The alarm component may be configured to generate a noise, a visual alert such as a flashing light, and/or an alarm signal that activates components of the system 100 as described in greater detail herein.

Alternatively, or in addition, upon detection by the system 100 that the entrance 106 has been opened without the system 100 actuating the lock mechanism 110 to the unlocked configuration, the alarm component may be activated. In embodiments, the alarm component is integrated with, or a function performed by a network access security device 124.

The control subsystem and/or the sensing subsystem of the remote security system 100 may comprise additional locking mechanisms and image capture devices as suitable. For example, a locking mechanism and/or image capture device may be provided for each entrance to a workspace 104. In FIG. 1B, a second entrance 130 in the form of a window is shown. As suitable, the second entrance 130 may comprise a respective locking mechanism suitable for the entrance and having analogous functionality to the locking mechanism 110. Additional and/or different entrances and locking mechanisms are contemplated by the disclosure. Corresponding signage may be provided for each possible entrance.

The remote security system 100 may comprise an image capture device 122 configured to capture an image or video of a workstation 120. The workstation 120 may be a computer, such as a desktop computer, a laptop computer, a tablet, or otherwise. In embodiments, the remote security system 100 may be configured to cooperate with an existing computer belonging to an employee and utilized for remote work. In other embodiments, the workstation 120 may be a company-provided computer or a computer provided with the other components of the remote security system 100.

The image capture device 122 may be configured to be removably attached or installed in the workspace 104 and facing the workstation 120. The image capture device 122 may be a camera of any suitable variety as described above regarding the camera 112. The camera 122 may be selected, installed, and/or operated so as to capture at least one image or video of a user at the workstation 120, including any separate devices such as mobile phones or tablets that the user may be utilizing and/or the activities and information accessed or modified by the user on a display 126 of the workstation 120. The images or videos captured by the camera 122 may be utilized by the central server to determine unauthorized persons, devices, and/or activities or information at or proximate the workstation 120 or the space 104. In embodiments, additional cameras can be arranged such that a substantial entirety of the workspace 104 can be imaged simultaneously. Any suitable section of the workspace 104 can be imaged by a camera. Similarly, additional cameras can be arranged exterior to the space 104 for added security.

As described in greater detail herein, the central server may receive through the communication subsystem the images captured by the camera 122 and apply a suitable image processing modality to determine an unauthorized device, person, or activity. In embodiments, the central server may utilize a processing subsystem comprising a processor in cooperation with an artificial intelligence module to determine from the images or videos captured by the camera 122 an unauthorized device, person, or activity as described in greater detail herein. In embodiments, manual and/or automatic review of the image data may be used as suitable.

Upon determination by the processor of an unauthorized person, device, or activity, a network access security device 124 connected to the workstation 120 may be configured to automatically lock or deactivate the display 126 and/or a processing unit 128 of the workstation 120 to prevent unauthorized access to or modification of sensitive information through the workstation 120. Additionally, or alternatively, the alarm component may be activated. The network access security device 124 may be configured as a USB boot control or lock box.

Additionally, or alternatively, the network access security device 124 may lock or deactivate the display 126 and/or the processing unit 128 upon the alarm component being activated, such as by the system 100 detecting entrance into the workspace 104 by an unauthorized person or otherwise. In any event, the display 126 may be provided with a removable glare screen 127 for obscuring the display 126 outside of or away from the workstation 120, such that an unauthorized person is not able to see sensitive information on the display 126 without necessarily passing through the field of view of one of more of the image capture devices.

The network access security device 124 may provide network security in addition to physical security for the remote security system 100 by requiring that a user login to the workstation using predetermined credentials prior to activating the display 126 and/or the processing unit 128 of the workstation 120. In embodiments, the network access security device 124 and the workstation 120 may also be part of the human UI subsystem 24 and may require that the user provide a predetermined security or identification credential. For example, the identification credential may comprise a passcode, a smart card, a biometric identification, combinations thereof, or other identification credentials are discussed herein. The network access security device may comprise any necessary components for receiving any needed identification credentials, such as a card reader, a keypad, a fingerprint scanner, combinations thereof, or otherwise.

Turning to FIG. 1C, an alternative view of the remote security system 100 of FIG. 1B is shown. It will be appreciated that the alternative view shown in FIG. 1C may include all the elements and/or subsystems described in relation to FIG. 1B and thus these elements need not be described again in relation to FIG. 1C. As shown, the remote security system 100 of FIG. 1C also includes the exterior space 102 and the securable or secured workspace 104. The human UI subsystem may comprise a tablet 111 which may be implemented as part of the locking mechanism 110 for receiving at least one identification credential discussed previously. The tablet 111 may be any suitable device, such as a smartphone, tablet, or other device and may be provided during installation or a user's existing device may be utilized as the tablet 111 for cooperating with the locking mechanism 110. The tablet 111 may be provided with a mount 113, which may be a stand connecting to the ground, an attachment mechanism for attaching the tablet to a wall surface, or any other suitable device.

The tablet 111 may be configured to display a user interface (not shown) for the user to activate the remote security system 100 or other otherwise communicate with the other subsystems of the remote security system. The user interface may allow the user to activate the remote security system 100 from outside the secure space 104, with the system 100 operating in a sleep mode between uses, for example. The user interface may facilitate authentication of the user's identity using one of the identification credentials described above, such as a passcode, facial recognition scan, combinations of credentials, or otherwise.

The control subsystem of the remote security system 100 of the workspace 104 may include one signage element 108A configured to be removably attached inside the secured workspace 104 and proximate the workstation 120 or the network access security device 124. The network access security device 124 may define or comprise a processor and/or communication device configured to, in embodiments, facilitate access or denial of access by the workstation 120 to a network, power source, and/or third-party security operations center (“SOC”), and/or an image capture device 122B, as will be described below.

The signage element 108A may comprise any suitable indicia for designating the workspace 104 as a secure office environment, for example listing authorized persons, providing instructions for presenting required identification credentials to the locking mechanism 110, providing pertinent legal notices, specifying authorized activities and/or objects, combinations thereof, or otherwise. Any suitable attachment component may be used to adhere the signate element 108A in a suitable location such as on a wall of the secured workspace 104, including adhesives, hardware, magnets, or otherwise. The system 100 may include a window film 182 applied to the interior surface of the window or the exterior surface of the window, the window film 182 configured to make the windows opaque. It will be appreciated that any suitable modality for obscuring visibility through the window may be utilized as suitable.

A sensing subsystem of the remote security system 100 of FIG. 1C may include multiple image capture devices 122A, 122B, 122C. The image capture devices 122A, 122B, 122C may be mounted to a wall as shown in FIG. 1A. In addition to or alternatively, one or more of the image capture devices 122A, 122B, 122C may be mounted on a tripod (as shown in FIG. 1C) or some other moveable stand at various locations in the secured workspace 104 to thereby allow for monitoring of different portions of the secured workspace 104 and/or monitoring from different angles. The image capture devices 122A, 122B, 122C define, respectively, fields of view 123A, 123B, 123C, which may be arranged within the workspace 104 so as to be complementary to each other. An image capture device 122A, 122B, 122C may also be placed on top of or proximate the workstation 120 or the network access security device 124 so as to be proximate a user who is using (or attempting to use or otherwise access) the workstation 120, thus enhancing any detection of the use of the workstation 120. The image capture devices 122A, 122B, 122C may define one or more room cameras 122A, 122C and/or one or more desk cameras 122B, as suitable.

The image capture devices 122A, 122B, 122C may be a same type or resolution of camera or may be different types and/or resolutions as suitable. For example, one of the image capture devices 122A, 122B, 122C may be an infrared or near-infrared-type camera for detection of possible intruders within the secure workspace 104 in the dark. As another example, one of the image capture devices 122A, 122B, 122C may be particularly configured to human key point or key area detection, facial key point or key area detection, and/or object detection, or any other suitable modality.

The sensing subsystem of the remote security system 100 of FIG. 1C may additionally or alternatively include various sensors and other devices that may be connected to the remote security system 100 by wired or wireless connections such as Wi-Fi and Bluetooth and thus be considered as part of the Internet of Things (IoT). For example, a door sensor 140 may be mounted on or placed proximate to the door 106 and may detect when the door 106 is opened or closed. A window sensor 150 may be mounted on or proximate the window 130 and may detect if the window 130 is opened or closed. A motion sensor 160 may be mounted on a wall, other furniture, the workstation 120, or any other suitable location in the secured workspace 104 and may detect any motion in the secured workspace 104. Further sensors 170 such as a smoke sensor that detects smoke may also be mounted in any suitable location of the secured workspace 104. The further sensors 170 may also include a microphone that is able to detect activity within the workspace 104, particularly during unauthorized times, when an authorized user is not detected, and/or when the workspace 104 is dark.

It will be appreciated that is some embodiments the secured workspace 104 may include all of the described sensors or only a subset thereof. In addition, in some embodiments, the secured workspace 104 may include more than one of the described sensors. As will be described in more detail, the various sensors 140, 150, 160, 170 of the secured workspace 104 may be configured to cooperate with the one or more image capture devices 122A, 122B, 122C to provide information regarding the presence of an authorized person and the presence of an unauthorized person, object, and/or activity. Not shown is a microphone that may be provided separately from an integrated microphone of a workstation, the microphone configured to detect activity within the workspace 104, particularly during unauthorized times, when an authorized user is not detected, and/or when the workspace 104 is dark.

The human UI subsystem of the remote security system 100 of FIG. 1C may include a button 180 such as an exit button that allows an authorized occupant of the secured workspace 104 to open the door 106 when leaving the secured workspace. Pressing the button 180 may cause the locking mechanism 110 to unlock the door 106. The button 180 may be placed in any reasonable location in the secured workspace 104, for example proximate the door 180 or proximate the workstation 120. In embodiments, the button 180 is accessible through a user interface displayed on the workstation 120 and provides a predetermined length of time during which the door 106 is unlocked, such as five seconds, ten seconds, or any other suitable length of time. In embodiments, the button 180 is wirelessly connected to the remote security system 100.

A method of installing a remote security system 100 according to embodiments of the present disclosure may include one or more of the following steps, not necessarily in the depicted order. Fewer or additional steps may be utilized as suitable. A first step of the installation method may include applying signage 108, 108A in suitable locations, including exterior to the secure space 104 and within the secure space, with the signage 108, 108A providing one or more indicia regarding requirements of the secure workspace 104, such as authorized persons and/or objects. A second step of the method may include covering one or more windows, if any, of the secure workspace with a suitable film such that sensitive information on a workstation may not be freely seen through the window. The film may be applied on an interior or exterior surface of the window.

A third step may include attaching window and/or door sensors within an interior of the workspace. The window and/or door sensors may be installed proximate the window and/or door, respectively, so as to detect whether a window or door is ajar at any time. A fourth step of the installation method may include a step of positioning a network access security device in a suitable location within the space, such as on a desk. In embodiments, the network access security device is provided with a power source such as a power pack comprising a battery. The provision of a power pack advantageously allows for the system to continue monitoring the workspace even in the event of a power loss in the user's home.

A fifth step of the installation method includes arranging one or more image capture devices within the workspace. The one or more image capture devices may be arranged such that the fields of view of the cameras are complementary to the other cameras; one camera may be provided as a desktop camera with the user's workstation or with the network access security device and may be connected thereto for power and information transmission. Another camera may be arranged on a wall, a piece of furniture, or on a mount such as a tripod in any suitable location, such as a corner of the workspace, such that a maximum percentage of the workspace interior may be captured within the field of view of the camera. Any number, type, and combination of cameras may be provided. A camera not arranged proximate the network access security device, i.e., in a corner or on a wall, may be plugged into the wall for a power source and/or for connecting to the system 100.

A sixth step of the installation method includes installation of an external tablet and corresponding mount. The tablet may be any suitable device for cooperating with the system and/or a lock mechanism and may be installed using any suitable mount, such as a mount attached to the wall and/or the floor. The tablet and mount may be arranged proximate and external the door so the tablet may present a user interface for activating and authenticating the system. The external tablet may be powered by a power cord connecting to a suitable power source.

A seventh step of the installation method includes installing an interior tablet and optionally a corresponding mount. The interior tablet may likewise be located proximate the door and inside the workspace. The interior tablet may be plugged into a wall socket using a power cord for a power source. Installation may include a step of activating the external and/or the internal tablet.

An eighth step of the installation method includes utilizing a setup feature of a user interface via the internal tablet to activate the network access security device, to configure Wi-Fi connections, and/or to calibrate and register camera locations. A ninth step of the installation method includes verifying the setup of the internal components at the SOC and/or the central server.

A method for using the remote security system includes one or more of the following steps: activating the system using the external tablet, authenticating a user's identity using a user interface provided on the external tablet, entering the workspace upon access being granted and securing the door closed after entering, opening or activating the workstation such as a laptop computer per normal operation, and when finished working, signing out of the remote security system using the internal tablet. In embodiments, the method for using the remote security system includes a step of powering down the system.

The method for using the remote security system further includes the steps of acquiring information from the remote security system, such as identification credentials, image data, IoT sensor data, or otherwise, transmitting the information to a central server and/or to a client server, processing the information at the central server and/or the client server, and receiving a signal, such as an alarm signal or an authorization signal, from the central server and/or the client server.

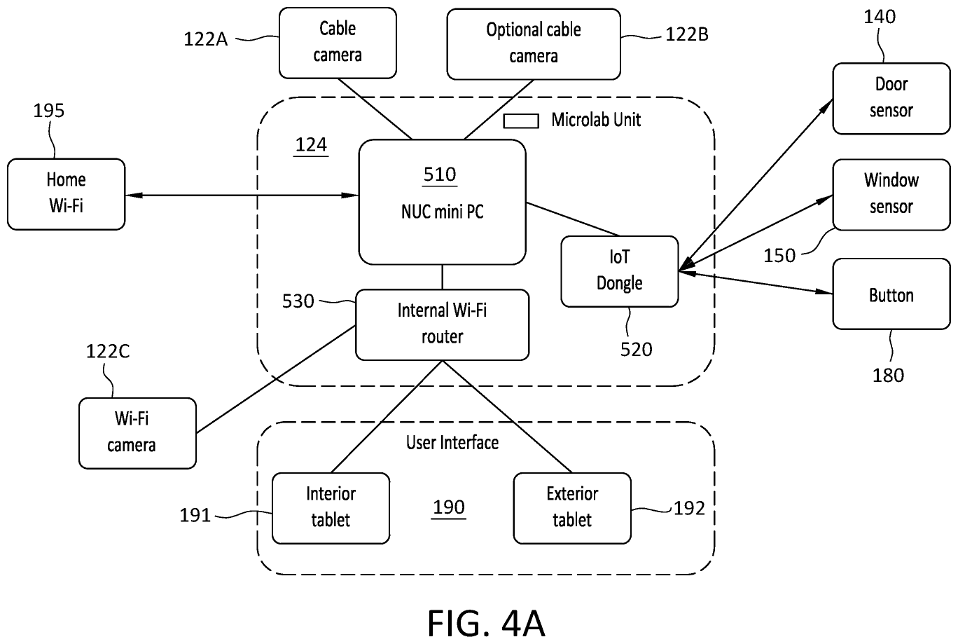

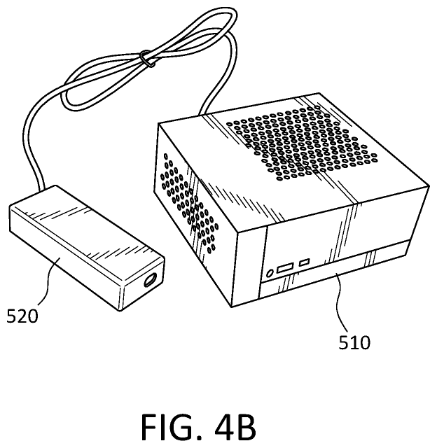

Turning to FIGS. 4A and 4B, an embodiment of the network access security device 124 is shown, the network access security device 124 defining or cooperating with a control subsystem, a communication subsystem, a storage subsystem, a sensing subsystem, a human UI subsystem, and/or a processing subsystem as described above regarding FIGS. 1A-1C. The network access security device 124 may include a processor or computer portion 510, an IoT dongle 520, and an internal Wi-Fi router 530. The processor portion 510 may define or cooperate with a processing subsystem and/or a storage subsystem and may connect with a Wi-Fi or other network connection of the secured workspace 104 through the internal Wi-Fi router 530, for example. The Wi-Fi router 530 may define or cooperate with a communication subsystem. The processor portion 510 may communicate or cooperate with a home internet connection, such as a home Wi-Fi network 195.

This may allow the processor portion 510 to communicate with a central server as will be explained in more detail here below. In some embodiments, the image capture devices 122A, 122B, 122C, defining or cooperating with a sensing subsystem, may be implemented as cable cameras that are connected directly to the processor portion 510 via USB cables or other suitable cables. The USB cables may define or cooperate with the communication subsystem. In other embodiments, the image capture devices 122A, 122B, 122C are connected wirelessly to the processor portion 510. The processor portion 510 may be or comprise any suitable processor, such as an Intel NUC 10 mini PC available from Intel Corporation of Santa Clara, Calif. In addition, or alternatively to being connected to the IoT dongle 520 and/or the internal Wi-Fi router 530, the processor portion 510 may connect to a security operations center (“SOC”) housing, cooperating with, and/or operating the central server. The SOC may define or cooperate with a human monitoring subsystem or with the processing subsystem. In some embodiments, the network access security device 124 may be located at or part of the SOC.

The IoT dongle 520 may be external to the processor portion 510 and may be connected to the processor portion 510 by a cable as shown in FIG. 4B. The IoT dongle 520 may define or cooperate with the communication subsystem and/or the sensing subsystem. The IoT dongle 520 may include wired or wireless communication connections such as Wi-Fi or Bluetooth that allow the IoT dongle 520 to communicate with the various IoT sensors such as the door sensor 140, the window sensor 150, the other sensors 170 such as the microphone, the exit button 180, combinations thereof, or any other sensors. The IoT dongle 520 may then provide any detection information obtained by the various IoT sensors to the processor portion 510.

The Wi-Fi router 530 may be internal to the same housing as the processor portion 510 and/or the IoT dongle 520 and may be connected through any suitable modality thereto. The housing including both the processing portion 510 and the Wi-Fi router 530 is shown in FIG. 4B. However, in some embodiments the Wi-Fi router 530 may be external to the housing of the processor portion 510 and may connected by a cable in the same manner as the IoT dongle 520. The Wi-Fi router 530 may define or cooperate with a communication subsystem of the remote security system and may communicate with a user interface 190 of the secured workspace 104 that may be part of the human UI subsystem. The user interface 190 may comprise, cooperate with, or be executed by or on an interior tablet computer 191 and an exterior tablet computer 192 such as the tablet shown in FIG. 1C. The user interface 190 allows for an authorized occupant of the secured workspace 104 to provide instructions via the Wi-Fi router 530 to the processing portion 510.

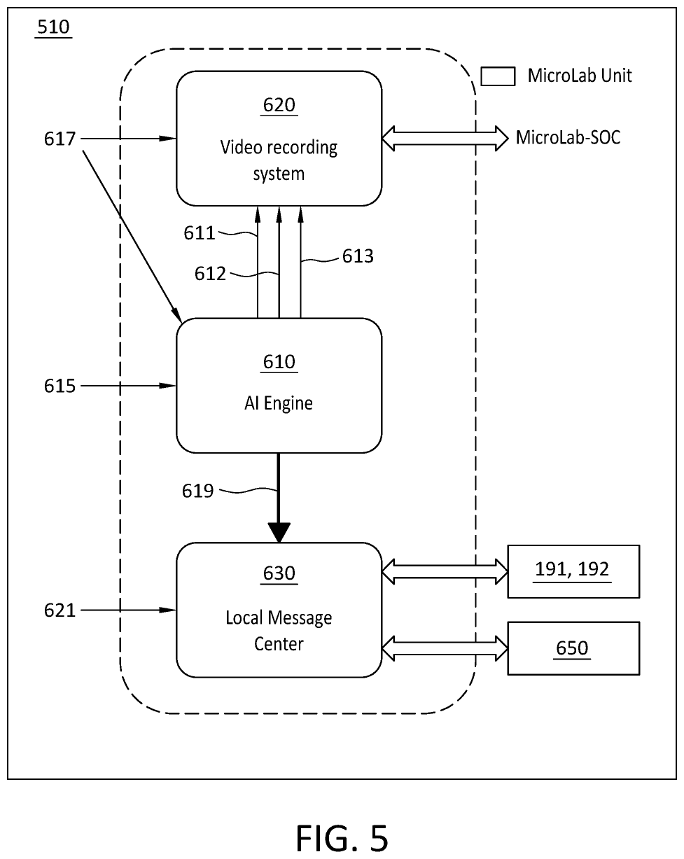

Turning to FIG. 5, an example embodiment of the processor portion 510 defining, comprising in part or in whole, or cooperating with a processor subsystem or a central server is shown. The processor portion 510 includes an AI module or engine 610. The AI module 610 may receive raw video streams 615, 617 from one or more of the image capture devices 122A, 122B, 122C of the sensing subsystem, which may be in some embodiments an AI camera, yielding the raw video streams 615, or a non-AI camera, yielding the raw video streams 617. The AI module 610 uses the raw video 615, 617 to identify objects of interest and/or to detect one or more persons using human detection in the secure workspace 104 and/or human pose estimation or any other suitable method. The AI module 610 may then output events 619, like the detection of a specific object of interest such as a cellphone or a change in the number of occupants in the secured workspace 104, to a local message center module 630 defining or cooperating with a communication subsystem. The AI module 610 may also output raw-video streams 611, AI-overlay streams 612, or AI-only streams 613 to a video recording system 620. This functionality will be described in more detail to follow.

In some embodiments, the AI module 610 may also output a privacy protection output video stream in addition to or alternatively to the output raw-video streams 611, AI-overlay streams 612, and AI-only streams 613. In such embodiments, the privacy protection output video stream may be configured to protect the privacy of any subject that is captured by the image capture devices 122A, 122B, 122C. For example, the privacy protection output video stream may include video where facial features, other bodily features such as skin color or hair color, and other identifying features such as tattoos or birthmarks of an occupant of the secured workspace 104 are blurred or otherwise made indistinguishable. In addition, the privacy protection output video stream may include video where identifying features of an object within the secured workspace 104 such as a name plate or family picture may also be blurred or otherwise made indistinguishable. Further, the privacy protection output video stream may include video where identifying features of the secured workspace 104 itself are blurred or otherwise made indistinguishable. In other embodiments, there may be no need for a privacy protection output video stream as the AI module may be configured to provide privacy protection to one or more of the output raw-video streams 611, AI-overlay streams 612, and AI-only streams 613 by blurring or making indistinguishable any identifying features of an occupant or object within the secured workspace 104 or any identifying features of the secured workspace itself. The AI module 610 may generate the privacy protection output video stream using a privacy protection module or model, it may generate the privacy protection output video stream using one of the other AI modules or models disclosed herein, or it may generate the privacy protection output video stream using a combination of the privacy protection module or model and one of the other AI modules or models disclosed herein. The use of the privacy protection output video stream advantageously provides privacy protection of the video stream at the time the video stream is generated and thus helps to prevent non-secure video from being leaked onto the Internet or other network since the video stream is privacy protected when generated.

The video recording system 620, defining or cooperating with a storage subsystem, records raw videos 611 from the non-AI image capture devices 122A, 122B, 122C and rendered videos from the AI module 610 such as the AI-overlay steams 612, the AI-only streams 613, or the privacy protection output video streams. The video recording system 620 also creates video streaming URLs from the raw videos 615, 617 and/or rendered videos 619 and provides these to the central server of the SOC, defining a human monitoring subsystem, utilizing the communication capabilities of the Wi-Fi router 530.

The local message center module 630, defining or cooperating with a communication subsystem, listens to the events 619 generated by the AI module 610 such as the detection of an object of interest, such as the detection of the presence of a cellphone or the change in the number of occupants. The local message center module 630 also listens for events 621 from the various IoT sensors of the sensing subsystem such as the door sensor 140 indicating the door 106 is open or the window sensor 150 indicating the window 150 is open. The local message center module 630 may then report these events to the central server 650 of the SOC, utilizing the communication capabilities of the Wi-Fi router 530 when communicating with the central server. The detected events may also be sent by the local message center module 630 to one or both of the interior tablet 191 and the exterior tablet 192. The local message center module 630 may be configured in embodiments to broadcast a message to a client-developed utility to disable a local PC or other device upon determination of a security breach.

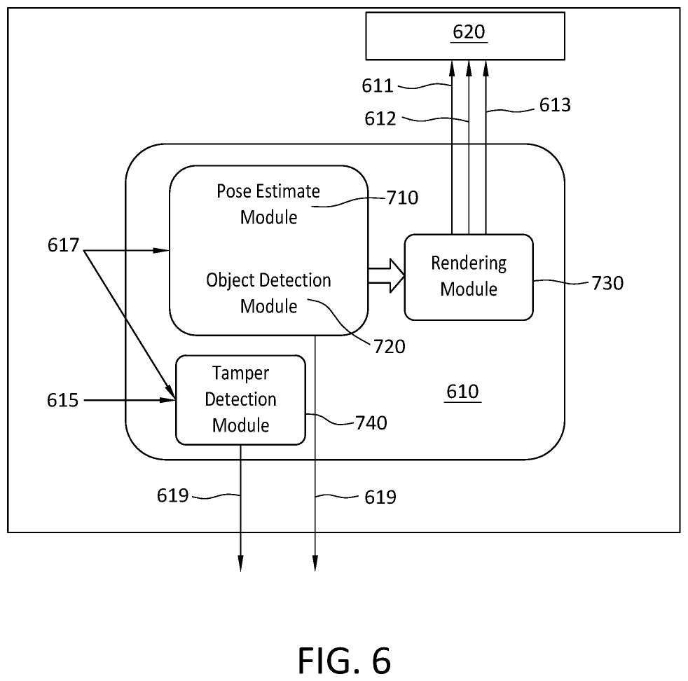

Turning to FIG. 6, an example embodiment of the AI module 610 is shown. The AI module 610, defining or cooperating with the processing subsystem, includes various modules that are able to cooperatively or independently perform the functions of the AI module 610. For example, the AI module 610 includes a human pose estimation module 710. As will be described in more detail to follow, the human pose estimation module 710 is configured to use the videos received from the various image capture devices 122A, 122B, 122C to determine the number of occupants in the secured workspace 104.

Alternatively, or additionally, an object detection module 720 uses the videos received from the various image capture devices 122A, 122B, 122C to determine an object of interest in the secure workspace 104. In this way, the remote security system 100 is able to detect if items, such as cellphones, cameras, or other recording devices that may not be allowed into the secure workspace 104 as they can be used to record sensitive data, have been brought into the secure workspace 104. A rendering module 730 is able to or configured to render the received video streams from the pose estimation module 710 and/or the object detection module 720 into the AI-overlay or AI-only channels 612, 613 before providing the video streams 611, 612, 613, or privacy protection output video streams to the video recording system 620. One or both of the object detection module 720 and the pose estimation module 710 may output an event 619 to the local message center 630.

The AI module 610 may also include a camera tamper detection module 740. This module uses AI functionalities to determine if one or more of the image capture devices 122A, 122B, 122C has been tampered with in any way by assessing the raw video feeds 615, 617. This helps to prevent an unauthorized occupant from being able to avoid detection by tampering with the image capture devices 122A, 122B, 122C. The tamper detection module 740 may utilize any suitable modality to detect tampering. The tamper detection module 740 may output an event 619 to the local message center 630 as suitable.

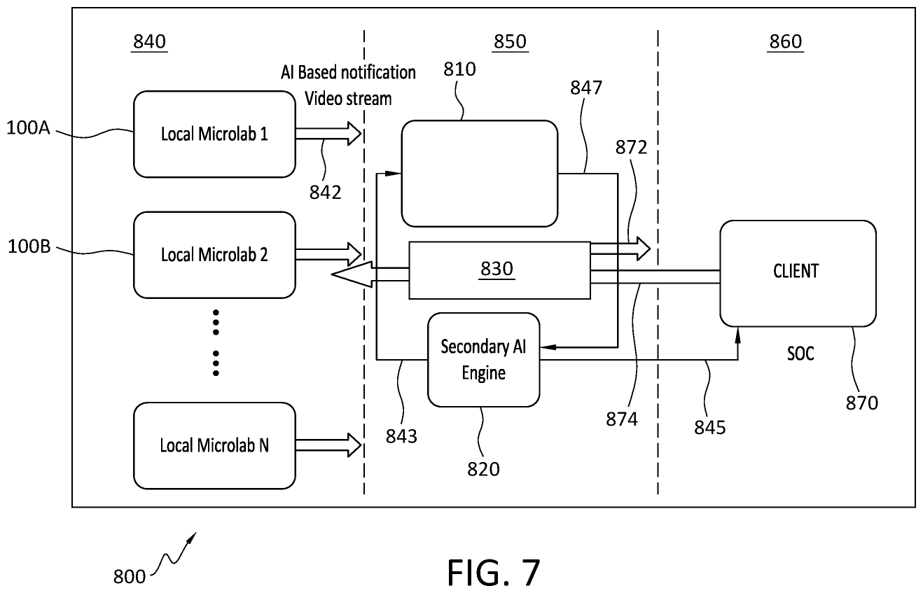

Turning to FIG. 7, an example embodiment of a central server 850 is shown. As illustrated, the central server 850 is able to communicate and cooperate with any number of remote security systems 100A, 100B, and so on, such as the remote security system 100 comprising or cooperating with a sensing subsystem, a processing subsystem, a storage subsystem, and/or a control subsystem, as previously described, as part of a remote security management system 800. The remote security management system 800 may comprise discrete layers 840, 850, 860, a first layer 840 comprising one or more remote security systems 100 corresponding individually to separate locations and/or users if suitable, a second layer 850 comprising the central server including a central database 810 defining or cooperating with a storage subsystem and/or an AI module 820 defining or cooperating with a processing subsystem, and a third layer 860 comprising a client server 870 defining or cooperating with a human monitoring subsystem. The central server 850 may be located at any suitable location or locations.

The central server 850 may include a central database 810 defining or cooperate with, in whole or in part, a storage subsystem. The central database 810 utilized by the central server 850 may receive information 842 (i.e., the AI-based video streams and notifications from the various IoT sensors, which streams and/or notifications may be live or recorded) from one or more remote security systems 100, including the image capture devices 112, 122A, 122B, 122C, the lock mechanism 110, the network access security device 124, and other components to track activity within the workspace 104 as described. For example, the central database 810 may comprise instructions regarding authorized or expected hours in which a user may be working in the workspace 104, including based on the employer's preferences and/or observed patterns from the individual user or other users.

The central database 810 may further comprise identification information corresponding to authorized users against which information obtained at the lock mechanism 110, the image capture devices 112, 122A, 122B, 1212C, the network access security device 124, or other components may be compared to authenticate a user as an authorized person. In some embodiments, a time limit may be set specifying how long the information received from the remote security system 100 is maintained at the remote security management system 800 to help maintain privacy.

The central database 810 may be configured to retain information regarding the remote security systems 100A, 100B, including part or all of the information obtained through the cameras and IoT sensors, for a predetermined length of time, for example 90 days. While 90 days is contemplated, it will be appreciated that any length of time may be utilized; for example, the database 810 may not store part or all of the information at all, or in embodiments the database 810 may retain the information permanently.

The remote security management system 800 and the central server 850 may have an AI module 820 functioning in embodiments as a secondary AI engine, which may utilize any reasonable AI functionality as described herein in relation to the AI module 610. The AI module 820 may define or cooperate with a processing subsystem. The AI module 820 may act to confirm the information and notifications determined by the AI module 820 and/or to conduct AI functions external to the AI module 610, thus offloading a portion or an entirety of a processing load on the AI module 610 transmitted at 847. This helps to prevent any false detections of an unauthorized occupant of the secure workspace 104. The AI module 820 may be configured to provide interaction with a client SOC 870 regarding any of the information discussed herein through at least one system-specific application programming interface (API). The at least one system-specific API may be based on the HTTPS protocol with token exchange and may be configured to facilitate direct interaction with the remote security system through API calls by a client.

In embodiments, the remote security system 100 is configured to generate a first or preliminary notification regarding a secured workspace, for example regarding a presence of a user or an object in the workspace. The remote security system 100 may be configured to transmit the first notification 842 to the central server 850 which may independently assess the first notification and optionally the inputs to the remote security system to filter out false positives and/or false negatives. A first notification 842 may be sent directly to the central database 810 or a first notification 849 may be sent directly to the secondary AI engine 820. In embodiments, the first notification 842, 849 is sent to both the central database 810 and the secondary AI engine 820. The AI module 820 may provide an AI-based notification 843 to the central database 810 upon confirming or supplementing a video feed or other information obtained from a remote security system 100. Alternatively, or additionally, the AI module 820 may provide an AI-based notification 845 directly to the client server 870, as will be discussed in greater detail here below.

For example, in one instance a pet of an authorized occupant may enter the secure workspace 104 and may be detected by the remote security system 100. As will be appreciated, since a pet is unable to access any sensitive data, there may be no need for the remote security system 100 to take any action such as deactivating the workstation 120. In embodiments, the system 100 may be configured instead to push an alert to a user's device, such as a smartphone, informing the user of the presence of the pet.

The remote security management system 800 may have a communication module 830 configured to receive information from the remote security systems 100A, 100B and transmit information to the remote security system 100A, 100B in substantially real-time. The communication module 830 may define or cooperate with, in whole or in part, a communication subsystem. The remote security management system 800 may further communicate with a hosting entity, such as an employer of the user, through the communication module 830 regarding any alerts, non-compliance events, or other issues. The remote security management system 800 may be configured to provide an image or video of the workspace 104 annotated or edited as suitable to the employer upon request, automatically, or as otherwise necessary or suitable. For example, the remote security management system 800 may provide the image or video of the workspace 104 on a predetermined schedule or interval, such as daily, or upon request such as to confirm that an alert generated by the remote security system 100 is legitimate and not a false alarm.

The remote security management system 800 further comprises a client server 870 as part of the third layer 860, the client server 870 defining or cooperating with, in whole or in part, with a human monitoring subsystem. The client server 870 may be or cooperate with a SOC specific to a client, i.e., a third-party organization. The client server 870 may be configured to receive through the communication module 830 one or more confirmed notifications 872 and/or video streams or other information from the central server 850 regarding an access request or a possible breach. The client server 870 may respond to the confirmed notification by providing, for example, an access authorization code 874 upon receiving which the pertinent remote security system 100 is configured to unlock the door 106 and/or activate a workstation. Alternatively, the client server 870, upon receiving a confirmed notification of a breach, may send an alert code 874 upon receiving which the pertinent remote security system 100 is configured to lock a door 106 and/or deactivate a workstation.

Although the description of the remote security system 100 described above has been in the context of a single security system for the secure workspace 104, this need not be the case. The embodiments disclosed herein provide for multiple remote security systems 100 that can be used by multiple authorized users in the secured workspace 104. Accordingly, the multiple remote security systems 100 may function and be configured in the manner described previously. This allows for access control of several users in the same secure workspace 104 as needed.

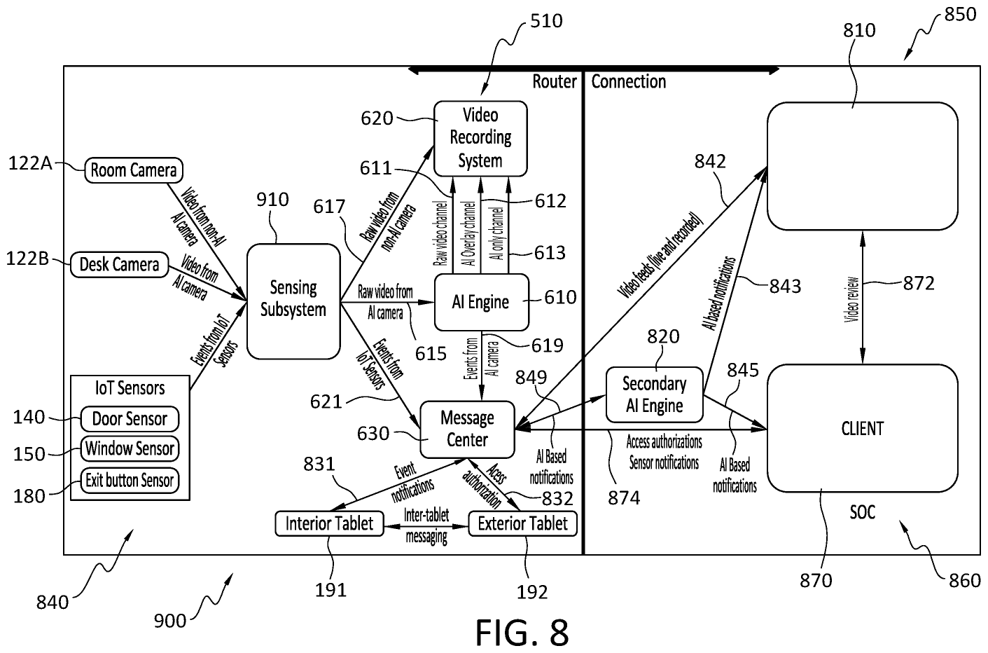

Turning to FIG. 8, an embodiment of a remote security management system 900 is shown and described. The remote security management system 900 may comprise a first layer 840 including a sensing subsystem 910 of a remote security system 100 configured to receive one or more inputs from one or more sensors, including a door sensor 140, a window sensor 150, an exit button 180, a motion sensor, a smoke sensor, a microphone, a desk camera 122B, and/or a room camera 122A, 122C, as described above regarding FIG. 1C. The sensing subsystem 910 may comprise one or more cable-connected cameras and/or one or more Wi-Fi-connected cameras as suitable. In embodiments, the Wi-Fi-connected cameras are connected through an internal Wi-Fi router.

Any number or combination of sensors may be provided. The sensing subsystem 910 may be configured to cooperate with a processor portion 510 as described above regarding FIG. 5. The processor portion 510 may include a video recording system 620, an AI engine 610, and a message center 630. The AI engine 610 may be configured to receive a raw video stream 615 from the sensing subsystem 910 through any suitable modality, such as by an internal Wi-Fi router, by wired connection, or by any other suitable connection. The raw video stream 615 may be a video stream obtained using an AI camera.

The video recording system 620 may be configured to receive a raw video stream 617 from the sensing subsystem 910, such as a video stream from a non-AI camera. The video recording system 620 may also be configured to receive from the AI engine 610 one or more of a raw video channel 611, an AI-overlay video channel 612, an AI-only video channel 613, or a privacy protection output video channel. For example, the AI engine 610 may be configured to use a trained machine learning model to perform detection on one or more frames of a video according to any suitable AI-based, computer vision-based, or other approach.

The message center 630, defining or cooperating with a communication subsystem, may be configured to receive events 619 from the AI engine 610 and/or events from the IoT sensors 140, 150, 180. The message center 630 may be configured to communicate with the interior tablet 191 and/or the exterior tablet 192, for example by transmitting and/or receiving through any suitable modality one or more event notifications 831 and/or access authorizations 832 to the interior tablet 191 and the exterior tablet 192, respectively. The interior and exterior tablets 191, 192 may communicate with each other. While the above embodiment has been described, it will be appreciated that any suitable connection between any of the components of the remote security management system 900 may be utilized within the scope of the present disclosure.

The message center 630 may also be configured to communicate with the second and/or third layers 850, 860 of the remote security management system 900. The message center 630 may be configured to send or receive information 842 (i.e., the AI-based video streams and notifications from the various IoT sensors, which streams and/or notifications may be live or recorded) to the central database 810, a first notification 849 to the secondary AI engine 820 (defining or cooperating with a processing subsystem), and/or an access authorization code 874 or an alert code 874 from the client SOC 870, the client SOC 870 defining or cooperating with a human monitoring subsystem. The message center 630 may utilize any suitable communication modality, for example a wired or wireless internet connection.

As seen in FIG. 8, in embodiments the components of the first layer 840 may be connected to each other and communicable through components of the communication subsystem, for example an internal Wi-Fi router, while the components of the second layer 850 and the third layer 860 may be connected to each other and to the first layer 840 through a wired or wireless internet connection. While an internet connection has been described, it will be appreciated that any suitable modality for connecting components of the remote security management system 900 may be utilized, including a local area network (LAN), a wireless area network (WAN), Bluetooth, combinations thereof, or any other suitable modality.

The secondary AI engine 820 may communicate with the central database 810, defining or cooperating with a storage subsystem, and/or the client SOC 870 by sending or receiving, for example, one or more AI-based notifications 843 to the central database 810 and/or the client SOC 870. The central database 810 may communicate directly with the client SOC 870 by sending or receiving a video review, such that a notification to the client SOC 870 may be verified at three levels: the remote security system 100 where the preliminary notification was generated, the secondary AI engine 820, and the central database 810, such that false positives are filtered out, and false negatives are avoided. The client SOC 870 may be configured to send and/or receive an access authorization and/or a sensor notification directly through the message center 630 of one or more specific remote security systems 100.

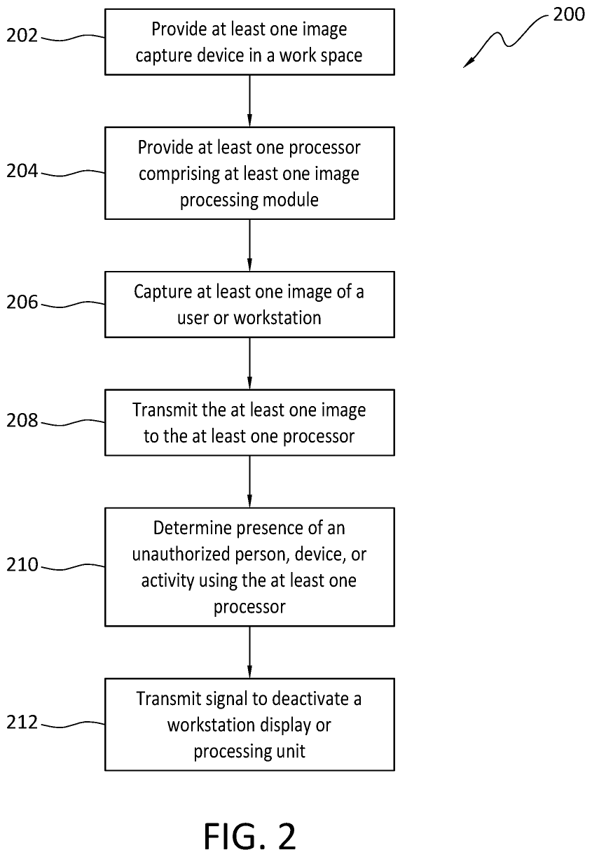

Turning to FIG. 2, a method 200 of using a remote security system according to embodiments of the present disclosure is shown. The method 200 may include a first step 202 of providing at least one image capture device in a workspace. As described herein, the at least one image capture device may be located in the workspace and may be configured to face a workstation such that a user, a user's devices, and/or the workstation display are visible within a field of the image capture device. A second step 204 includes providing at least one processor comprising at least one artificial intelligence (AI) module, such as an image processing module. The image processing module may be configured to assess an image or one or more frames of at least one video transmitted to the processor from the image capture device and to determine the presence of an unauthorized person, object, or activity being performed on the workstation.

A third step 206 includes capturing and optionally processing locally at least one image of a user or workstation. The at least one image may be a single image or may be a video comprising a plurality of frames. A fourth step 208 includes transmitting the at least one image to the at least one processor of the central server. This may be done using any suitable transmission modality, including wired or wireless transmission. The processor may be local or remote to the remote security solution.

The fourth step 208 of transmitting the at least one image to the at least one processor may include a single transmission or a plurality of transmissions. Additionally, the fourth step 208 may include transmitting a raw image or a raw video only, an artificial intelligence (AI) annotated video only, an AI-annotation-only video only, a combination thereof, or otherwise. For example, upon capturing the at least one image of the user or the workstation, the remote security system may utilize a suitable artificial intelligence modality configured to perform filtering, noise removal, edge detection, and/or color processing.

In the embodiments disclosed herein, the AI modality may include a computer vision modality including a facial recognition module or model, a pose estimation module or model, an object detection module or model, an objection recognition module or model, an object classification module or model, an object identification module or model, an object verification module or model, an object landmark detection module or model, an object segmentation module or model, a tracking module or model, a video annotation module or model, a privacy protection module or model, or any other suitable modality or model. It will be appreciated that there may be other AI modules or models that are also implemented as circumstances warrant.

Thus, in the embodiments disclosed herein the AL modules or models may be considered to fall into four general categories or classes: an object detection module or model class, an identification module or model class, an activity identification module or model class, and a privacy protection module or model class. Each of these AI module or model classes may include one or more modules or models. For example, the identification module or model class may include, but is not limited to, the facial recognition model, the tracking model, and pose estimation model. The object detection module or model class may include, but is not limited to, the pose estimation model, the object detection model, the objection recognition model, the object classification module, the object identification model, the object verification model, the object landmark detection model, the object segmentation model, and the tracking model. The activity identification module or model class may include, but is not limited to, the tracking model, and pose estimation model. The privacy protection module or model class may include, but is not limited to, a model that identifies a body part such as the face or other distinguishing feature of an occupant of the secured workspace 104 for blurring or otherwise making indistinguishable such as pixilation and a model that that identifies a portion of an object such as text on a paper of an object of the secured workspace 104 for blurring or otherwise making indistinguishable such as pixilation. Thus, the AI module or model classifications can have any number of related modules or models. In addition, the AI module or model classifications can share any number of modules or models as circumstances warrant.

In embodiments, the computer vision modality may process and annotate a captured image or one or more individual frames of a captured video with any suitable annotation, whether before, during, or after the fourth step 208. In embodiments, the computer vision modality may apply a bounding box around an identified person or object and/or a marker such as a virtual skeleton overlay superimposed onto the captured image of an identified person. In embodiments in which markers such as a bounding box or virtual skeleton overlays are applied onto the image or frame, the image or frame may be first captured as or converted to a mono-color frame (e.g., pure black and white).

In embodiments, skeleton markers defining a virtual skeleton overlay comprising for example one or more nodes and one or more body segments may be applied onto the image or frame when a person is detected, and one or more bounding boxes or classes may be applied onto the image or frame for identified objects. The bounding boxes may comprise a point, width, and height. The remote security system may further be configured to provide a label that specifies an identified class of an identified object and data specifying where the identified object appears in an image. The virtual skeleton overlay may define or cooperate with a human pose skeleton. The remote security system can be configured to perform multinomial classification to detect any suitable number of classes of objects, e.g., 10 types of classes, 50 types of classes, 80 types of classes, or any suitable number. In other embodiments, the remote security system may be configured to perform binary classification.

The remote security system may be configured to identify specific types of classes, such as person, window, curtain, blinds, wall, chair, desk, poster, camera, printer, whiteboard, credenza, filing cabinet, coffee table, decoration, artwork, door, badge, light, lamp, wrist watch, tablet, camera, monitor, laptop, mouse, remote, keyboard, mobile phone, smart watch, papers, folder, bag, carpet, floorboard, bookcase, book, pen, USB drive, cable, or any other suitable class of objects. The bounding boxes annotated on captured images may identify an object as one or more of the above classes or any other suitable class.

The remote security system can be configured to automatically determine whether the captured image or frame/video should be transmitted as a raw image or frame, as an annotated image or frame, or as annotation-only. This determination may be made in view of one or more legal requirements relating to privacy and security of information particular to a geographic location. For example, the remote security system may be configured to automatically determine based on the location of the remote security system whether to transmit a raw image or frame, an annotated image or frame, or annotation only to the at least one processor locally or at the central server. This determination may be made additionally or alternatively in view of the location of the at least one processor and legal requirements pertinent to said location. In alternative embodiments, the determination may be made manually, e.g., by a user or at the central processor, when initializing the remote security system and inputting user-specific preferences.

The user of the remote security system may indicate a preference of which type of image or frame to transmit in the fourth step 208. For example, a particular user may not wish to transmit an image containing images of a user or other individual in the secure home office, faces of the user or another person, the home office itself, and/or contents of the home office, such as sensitive work product, or identifying personal items including artwork, furnishings, or otherwise. Such a user may elect to send an annotation-only image or frame to the processor.

To facilitate transmission of the images or frames by one or more of the above-mentioned modalities, including raw image or frame, annotated image or frame, or annotation-only, one or more corresponding channels may be provided for executing the transmission. The remote security system may be configured to utilize a corresponding one of the channels upon a determination of which type of image or frame to transmit to the processor. The remote security system may be configured to use one and only one of the channels from a particular image or frame type in accordance with one or more legal requirements.

The raw image or frame may include an image or frame of a captured video only, which may be edited through one or more of the image processing modalities discussed herein or not. Transmitting an annotation-only frame or video may be advantageous for users who do not wish to transmit images of their face, person, or workspace contents. The selection of raw image or frame, annotated image or frame, or annotation-only image or frame may be based on the legal requirements of a jurisdiction where the remote workspace and/or the central server are located, and may be determined either manually by a user or automatically by the system.

A fifth step 210 includes processing the image or frame to determine a presence of an unauthorized person, device, and/or activity in the workspace using the captured image. The presence of an unauthorized person, device, and/or activity may be detected in a single frame of the captured image and may be determined against a central database of authorized users, uses, and activities. A sixth step 212 may include transmitting a signal to deactivate a workstation display and/or processing unit of the workstation. The sixth step 212 may not be taken if no detection of an unauthorized person, device, or activity is made. The signal may be transmitted in the sixth step 212 in any suitable manner as described herein and in substantially real-time.

By providing a method 200 as described herein, the remote security system and method embodiments advantageously facilitate the creation of a secure home office compliant with pertinent legal requirements and that ensures protection of sensitive information regardless of a user's work location. The remote security system and method advantageously may be simply and effectively installed in a user's home or other remote work location using modular components and at a lower cost than existing methods for securing a workplace.

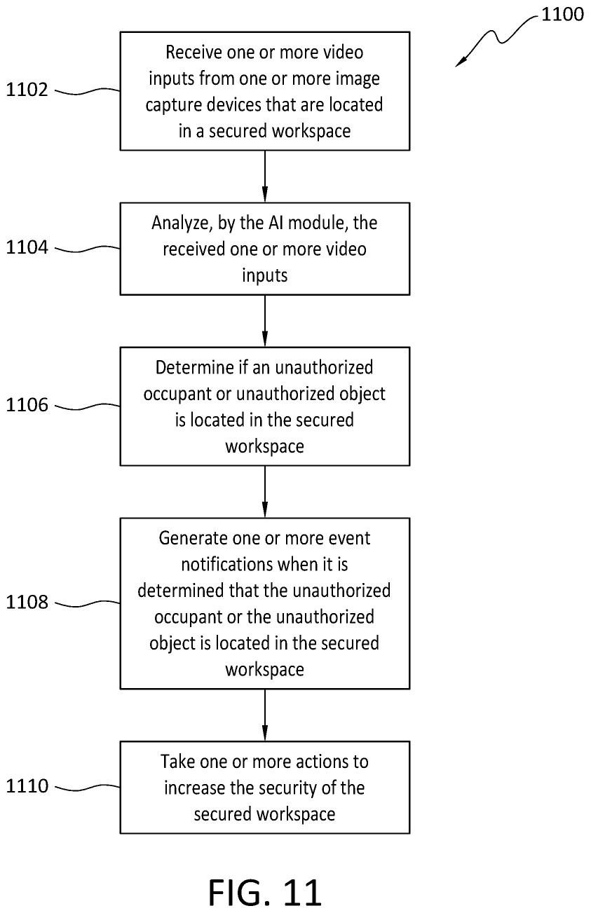

Turning to FIG. 11, a method 1100 for monitoring a remote secure workspace according to embodiments of the present disclosure is shown. The method 1100 may include a first step 1102 of receiving one or more video inputs from one or more image capture devices located in a secure workspace. For example, as described above, the video input may be received into the remote security system from the image capture devices 122. In addition, in some embodiments sensor input data may be received from one or more of the sensors 140-170. The image capture devices and the sensors may be located in the secure workspace 104 or near its exterior as previously discussed.

The method 1100 may include a second step 1104 of analyzing by an AI module the received one or more video inputs. In addition, in some embodiments, the sensor input data may be received. For example, as previously described the AI module, for instance AI module 610 or 820, can analyze the received input video and sensor data as discussed previously.

The method 1100 may include a third step 1106 of determining if an unauthorized occupant or unauthorized object is located in the secure workspace or if an unauthorized activity is being performed in the secured workspace. For example, as previously discussed the AI module 610 or 820 can determine if an unauthorized human is located in the secure workspace 104. In addition, or alternatively, the AI module 610 or 820 can determine if an unauthorized object such as a mobile phone is located in the secure workspace 104. Further, the AI module 610 or 820 can determine if an unauthorized activity is being performed in the secure workspace 104.

The method 1100 may include a fourth step 1108 of generating one or more event notifications when it is determined that the unauthorized occupant or unauthorized object is located in the secure workspace or that the unauthorized activity is being performed in the secured workspace. For example, as previously described the remote security system can send notifications, in some embodiments including the video input, to a remote client computing system that detail the determination of the AI module.

The method 1100 may include a fifth step 1110 of taking one or more actions to increase the security of the secured workspace. For example, as previously described the remote security system can take such actions as locking the door of the secured workspace 104, deactivating one or more computers such as the workstation 120 or blocking the one or more computers from the network, or sounding an alarm.

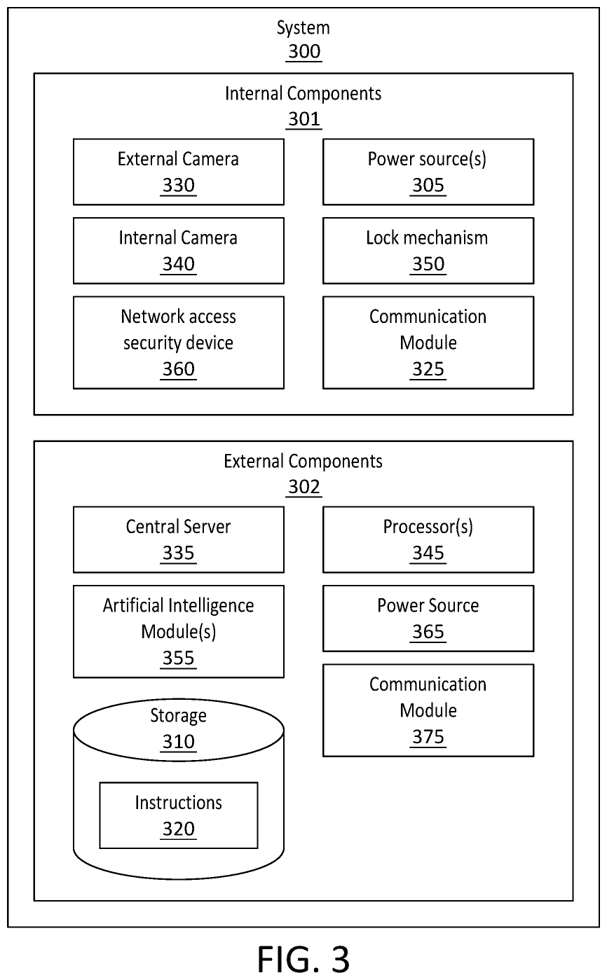

Turning to FIG. 3, a remote security system 300 may comprise both internal components 301 of a workspace and external or remote components 302 external to the workspace and located, for example, at a central location corresponding to a plurality of workspaces. The internal components 301 may include the external camera 330, internal camera 340, a power source 305, a lock mechanism 350, and a communication module 375. The external and internal cameras 330, 340 may be configured to be installable in a remote office or workspace and may face an entrance to the workspace and a workstation within the workspace, respectively. The external and internal cameras 330, 340 may connected to the system 300 through any suitable modality, including both wired and wireless connections.

The power source 305 may be configured to provide power to the external and internal cameras 330, 340 through suitable power means, including batteries, direct power, or otherwise. The power source 305 may additionally be connected to a lock mechanism 350 configured to be installed on an entrance to the workspace, such as a door. The lock mechanism 350 may be configured as described herein to receive at least one identification credential and to switch between a locked configuration and an unlocked configuration so as to permit or restrict entry and exit into and from the workspace. In embodiments, the lock mechanism 350 and components for providing or receiving identification credentials may be distinct components.

Internal to the workspace, a network access security device 360 such as a boot control box may be connected to a workstation, such as a personal computer of a user, including desktop computers, laptop computers, tablets, or otherwise. The network access security device 360 may receive instructions from the system 300 to lock or deactivate the workstation upon determination that an unauthorized person, device, or activity is present or taking place in the workspace, compromising the security of the workspace. The network access security device 360 may be connected to the power source 305.

A communication module 325 may facilitate communication between the internal components 301 and external components 302 of the system 300 as appropriate, for example to send images captured using the external and internal cameras 330, 340, identification credentials obtained at the lock mechanism 350, or identification credentials obtained through the network access security device 360. The communication module 325 may further receive information and signals from the external components 302, such as authentication communications from the central server 335 and/or a processor 345.

The external components 302 may include a storage 310 comprising instructions 320 that, when executed by a processor 345, cause the system 300 to receive identification credentials and/or captured images from the internal components 301 for example a central server 335. The instructions 320 may further cause the system 300 to apply an artificial intelligence module 355, such as a facial recognition module, to the captured images, or to compare the identification credentials against a database stored on the storage 310. The external components 302 may comprise a power source 365 connected to one or more of the storage 310, the processor 345, and the central server 335. In embodiments, the storage 310 may comprise legal requirements or information pertaining to one or more jurisdictions, and which may be accessed automatically by the processor 345 based on a detected or specified location of the workspace and/or the central server 335.

Upon a determination by the processor 345 that the identification credentials match an entry in the database, the external components 302 may send an authentication signal via a communication module 375, which the power source 365 may be connected to. In embodiments, the external components 302 may correspond to and cooperate with internal components 301 at a plurality of remote work locations. The processor 345 may advantageously determine unauthorized persons, devices, or activities at numerous users' locations, such as the employees of a company.

The remote security system embodiments are advantageously configured to be tuned at a per-room level by an administrator at the central server, for example using the AI secondary engine. The remote security system may be configured to define a type of notification that triggers an alarm and is classified as an event. A threshold of a confidence level of an event may be predetermined, a confidence level above the predetermined threshold triggering an alert. In embodiments, the remote security system may be configured, upon an alert being generated, to lock and/or disable a workstation. An identity of a user, such as a local user or a user at a SOC (either the central server or a client server) who may clear an alert, may be predetermined.

Similarly, a time interval for each action (such as opening a door, entering the room, closing a door, and any other suitable events) may be determined. The time intervals may be determined or changed using a user interface on any suitable device, such as one of the interior or exterior tablets, using the workstation, or otherwise. By providing the ability to tune the remote security system to specific workspace needs, downtime from system-disabling events or alerts, sensitivity of the remote security system to potential breaches, and a workload of the SOC are optimized and balanced. In an embodiment, a default state of all event triggers is set to “OFF.”

The remote security system of embodiments of the disclosure may be configured to pass data to security information and event management (“SIEM”) system or by API to the secondary AI engine. As described herein, the secondary AI engine may function to filter notifications and/or events generated by one or more remote security systems and send only action-required events to an SOC. This advantageously reduces the manpower required at the SOC. In embodiments, video information may be retained by default locally on the remote security system for a suitable period, such as a minimum of 60 days, and up to any suitable maximum length, such as 90 days. The video information may be retained by default on the central database for any suitable period, such as by default 12 months.

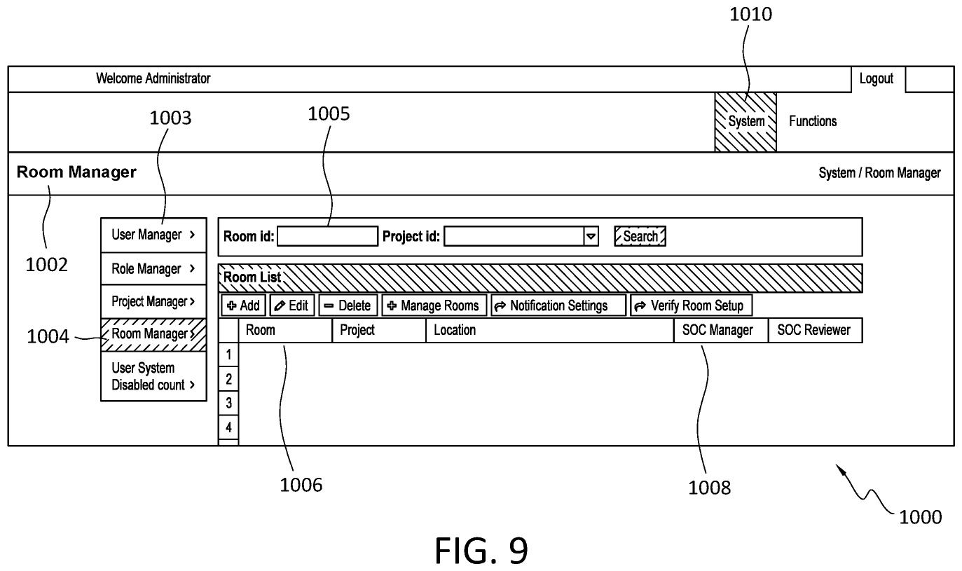

Turning to FIG. 9, a user interface 1000 for operating a remote security system according to embodiments is shown. The user interface 1000 may facilitate management of projects, workspaces/rooms, and users of one or more remote security systems 100, and may be used by a SOC, such as a client SOC at which one or more reviewer employees work. The user interface 1000 may manage a plurality of projects pertaining to one or more employers and may assign different workspaces to different SOC reviewers. The SOC reviewers can view events, monitor live streams, and handle events, escalate issues, verify room setups, run room scans using the system 100 or management system 900, or any other suitable function. The AI administrator may tune a particular remote security system's sensitivity and/or event threshold using the user interface 1000.

The user interface 1000 may define a role identifier or function 1002, such as a room manager interface. The function 1002 may be selected from a selection 1004 of functions, such as user manager, role manager, project manager, room manager, and user system disabled count. The user interface 1000 may further define a menu 1006 of different rooms or workspaces that may be managed using the interface 1000, and may identify a room, project, location, SOC manager 1008, and/or SOC reviewer, for example. A user may add, edit, delete an entry on the menu 1006, and may navigate to notification settings and/or to verify a room setup. One or more search bars 1005 may allow a user to search for particular rooms, projects, users, roles, etc. A user may toggle between a system management page 1010 and a functions page.

As seen, the user interface 1000 advantageously allows a user to manage multiple projects, customize notifications, customize event handling, and/or communicate with one or more remote security systems. This has the advantage that home privacy is protected from SOC view, room setup verification and room scan status can be easily accessed, API integration for ease of customization, and secondary review of the events is performed by the secondary AI engine such that only high-confidence events are forwarded to a client SOC and/or to a remote security system user.

One or more roles may be predefined in a remote security system or may be defined using the interface 1000. For example, an admin may specify all functions of the remote security system except, in embodiments, for changing AI thresholds and/or time intervals. An AI admin may change AI thresholds and time intervals for each room, in contrast to an admin.

An SOC manager may assign rooms and/or projects to different SOC reviewers, manage SOC reviewer information, handle escalated events, escalate events to an admin, etc. An SOC reviewer may manage authorized user and/or visitor information, including providing or managing a passcode to a workspace, view live streams and/or event details including video clips, escalate events, disarm the system remotely, and any other suitable function.

An authorized user may disarm the system locally when suitable, enter the room with a passcode or other authorized credential, and work at the workstation, in embodiments. The authorized user may not have access to the user interface 1000 above. A visitor may be enabled to enter the room with a passcode, but may not have access to the user interface 1000.

The user interface 1000 may allow an SOC reviewer to view workspaces assigned to them in one or more of three possible layouts, such as live scenes (for multiple workspaces), event streams, and/or watch events details (so as to process and/or escalate an event). The SOC manager may customize settings for projects, workspaces, and notifications, and assign an SOC reviewer to projects and/or rooms, and the SOC reviewer may easily manage projects and/or rooms.

The user interface 1000 may define one or more modules, including a user manager, a role manager, a project manager, a room manager, a notification manager, time interval settings, threshold settings, and/or user system disabled counts report. A user manager system module may facilitate the creation, deletion, updating, and reading/viewing of user information. The user manager system module may facilitate adding roles to users, and may allow multiple roles for a single user. If an authorized user leaves a job, they may immediately lose access to a workspace. If an SOC reviewer leaves their job, they may immediately lose access to the SOC, but their work including the event logs may remain stored in the SOC.

A role manager system module may facilitate the creation, deletion, updating, and reading/viewing of role information, selection of function access and permission for roles, listing information for one or more role groups, and/or filtering and searching of roles. A project manager system module may facilitate the creation, deletion, updating, and reading/viewing of projects, and/or adding workspaces and users, such as an SOC manager, to a project.

A workspace manager system module may facilitate the creation, deletion, updating, and reading/viewing of workspace information, adding users such as the SOC manager, SOC reviewer, authorized user, and/or visitor to pertinent workspaces. An AI admin may modify notification settings for each workspace, including the notification and/or thresholds.

A notification manager system module may facilitate the creation, deletion, updating, and reading/viewing notification/event information. Notifications may be customized in projects and workspaces. By default, all videos are disabled but become accessible once a video functionality is activated. Event video availability can be customized at the SOC for each workspace. The AI Admin may edit the settings to define who will receive and handle the notifications, whether the notification is classified as an event or not, who can view event details, and/or who can clear the alarm. This may be delegated to a local or SOC reviewer. The user interface may communicate with the local remote security system such that “Clear by,” “Enable video,” and “Modify threshold” functions/buttons are functional.

A time interval setting system module may facilitate the AI admin's modification of time intervals, for example a maximum time allowed for the door to remain open or unlocked after the authorized user passes the authentication step on an exterior tablet. This setting may be determined on the user interface 1000.

A threshold settings system module may facilitate the AI admin's modification of the threshold of the object detection. For example, the AI admin may tune the parameters/thresholds of each workspace from the user interface 1000 such that a global threshold for each room and/or for each object detection event are specified.

A user system-disabled counts report system module may facilitate the display of information on a number of times each user's system is disabled by an event. The module may list the user system disabled counts according to event types. This information advantageously assists with navigating a trade-off between security and disabled times, and further informs the tuning of parameters.

The user interface 1000 may define one or more function modules. A live monitoring function module may facilitate the live stream of each workspace to be viewed only by an assigned SOC reviewer. The live monitoring function module may permit the SOC reviewer to view the live stream and logs of each authorized room.

An events list function module may facilitate an event list of assigned workspaces to be displayed as a queue and to be refreshed automatically. The events list function module may show only relative events of a project/workspace that the user is assigned to. The module may further provide a filter and search function that are needed to look for a specific project, workspace, and/or event. The module may provide an action needed column that generates a “yes” value when the alarm cannot be locally cleared. The module may provide an escalated column that yields no value for Admin/SOC manager when an event is not escalated. The module may be configured to auto refresh by itself.

An events details function module may facilitate communication between the SOC and the remote security system, for example to disarm an alert, to contact a user, to resolve an event, and/or to escalate an event to a supervisor. The module may protect home privacy from SOV view and protect content privacy, such as monitors and keyboard. For each event, the SOC reviewers/SOC managers can view videos, contact the authorized user, resolve the event, edit the event at the SOC, and/or escalate the event. The SOC reviewer may escalate an event to the SOC manager, who can escalate an event to an Admin or AI Admin in the event that an event settings threshold needs to be changed. The SOC manager may manage escalated events.

A workspace setup verification function module may facilitate permission for an SOC reviewer to view the workspace setup and the workspace scan status. At the remote security system workspace managers interface, SOC users with permission may see a list of assigned workspaces and overview the statuses thereof. The list may be filtered and searched by workspace ID, project ID, user ID, and/or workspace status, and clicking a “verify room setup” button may navigate a user to a detail page of a workspace. In the workspace setup verification function module, a 2D reconstruction model displays the workspace setup status. SOC users may be able to communicate with an authorized user on workspace setup issues.

In an alternative embodiment of a remote security system, a workspace may be secured not for a single authorized user only but rather for a plurality of users who intend to work together in the workspace. The remote security system of such embodiments may comprise one or all of the features described above and may further provide advanced access control for several users, including facial recognition modalities. The remote security system embodiments for multiple users may advantageously help a business set up a small branch or office within a few hours while handling secure data in compliance with data protection laws. The remote security solution of embodiments may be configured to cooperate with any suitable networking, security, or other tools as suitable.

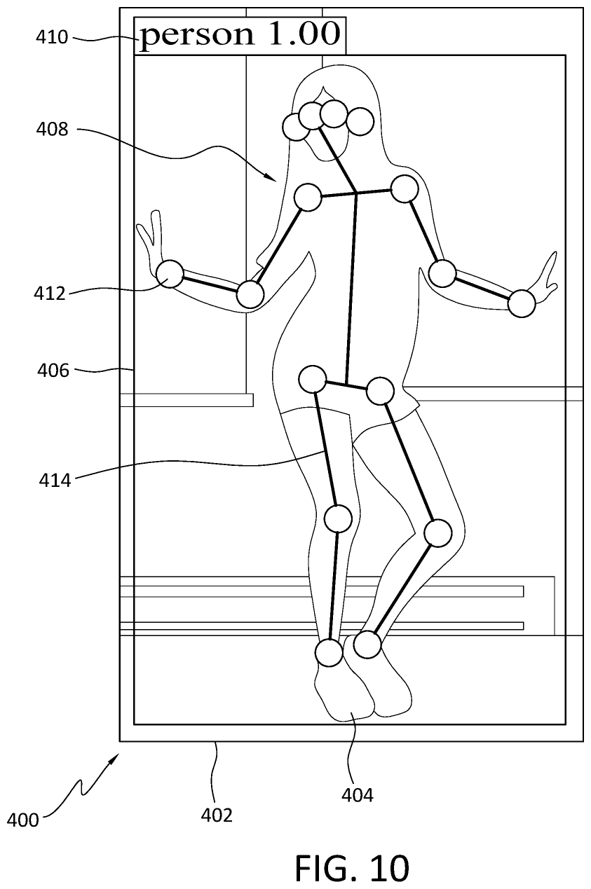

Turning to FIG. 10, an annotated frame 400 of a captured video is shown. The annotated frame 402 comprises a raw video frame 402 comprising a captured frame before annotations are applied onto the frame 402. The raw video frame 402 may be processed according to any suitable image processing modalities, including normalization of photometric properties of the frame, such as brightness or color, cropping the bounds of the frame, such as centering an identified object in the frame, and/or removing digital noise from the frame, such as digital artifacts from low light levels. The image or frame 402 may be processed locally at the remote security system or at the central server.

The raw video frame 402 which may have been subjected to image processing techniques as described above may be overlaid with one or more annotation components, such as a bounding box 406 that surrounds an identified object, such as a person 404 or an object. The bounding box 406 may include one or more labels 410 that identifies an identified object and indicates the class of the identified object and/or indicates the number of said object class that the identified object represents. For example, the label 410 may indicate that the person 1.00 is the first person identified by the remote security system in the class of persons.

The raw video frame 402 may further be overlaid with one or more virtual skeleton overlay components. In the depicted embodiment, a virtual skeleton overlay 408 comprises one or more nodes 412 which may be one or more joint nodes corresponding to an identified joint of the identified person, such as a wrist joint, an elbow joint, a shoulder joint, a hip joint, a knee joint, an ankle joint, combinations thereof, or otherwise. The nodes 412 may also or alternatively correspond to one or more key features such as facial features including one or more of a person's eyes, ears, mouth, nose, or otherwise. The virtual skeleton overlay 408 may further comprise one or more body segments 414 extending between one or more nodes 412. The one or more nodes 412 may advantageously define or include a key point or key area of a person.

The remote security system may use an artificial intelligence model configured for human pose estimation that utilizes key point or key area tracking and/or object tracking. In an embodiment, the human pose estimation model may be or utilize a deep neural net model. The processor may be configured to receive an image or frame of a video and overlay one or more key points or key areas and/or bounding boxes to identify a person in the workspace.

The system may be configured to detect and identify predefined key points or key areas on each presenter. There may be any suitable number of key points or key areas, for instance 17, 25, or any other suitable number. The key points or key areas may be predefined to correspond to a desired feature of a person, such as joints including the hip, knee, ankle, wrist, elbow, and/or shoulder, body parts such as the foot tip, hand tip, head top, chin, mouth, eyes, and/or ears, or any other suitable feature.

In embodiments, each key point or key area may be connected to a proximate key point or key area for purposes of visualization and ease of understanding. For instance, the left foot tip key point may be connected by a straight line to the left ankle, which may be connected by a straight line to the left knee, which may be connected by a straight line to the left hip, which may be connected by a straight line to the left shoulder, and so forth. The key points or key areas and the connecting lines therebetween may define a virtual skeleton overlay, which may be overlaid onto and transmitted with a captured image or frame of a video feed or transmitted independently.

While key points or key areas may be connected to each other by an overlaid connecting line, the system and method embodiments may be configured to perform the dynamic cropping operations described herein without overlaying a connecting line. Such connecting lines may be, in embodiments, merely artificial and exterior to the detection of key points and key areas, and provision of such connections may advantageously help visualize the detection, for example as a user at a SOC reviews the performance of the system.

Embodiments of the present disclosure may comprise or utilize a special-purpose or general-purpose computer system that includes computer hardware, such as, for example, one or more processors and system memory, as discussed in greater detail below. Embodiments within the scope of the present disclosure also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the disclosure.

Transmission media can include a network and/or data links which can be used to carry program code in the form of computer-executable instructions or data structures, and which can be accessed by a general-purpose or special-purpose computer system. A “network” may be defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions may comprise, for example, instructions and data which, when executed by one or more processors, cause a general-purpose computer system, special-purpose computer system, or special-purpose processing device to perform a certain function or group of functions. Computer-executable instructions may be, for example, binaries, intermediate format instructions such as assembly language, or even source code.

The disclosure of the present application may be practiced in network computing environments with many types of computer system configurations, including, but not limited to, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

The disclosure of the present application may also be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

By providing a remote security solution and method according to the present disclosure, the problems of existing WFH protocols and systems being insufficient to properly and effectively ensure the security of an employee workstation and/or sensitive information accessed, modified, or displayed thereon are addressed. The embodiments of a remote security system and method advantageously provide a modular, cost-effective, and robust security system effective at securing physical access and network access to a remote workstation by providing one or more of a camera system, a lock mechanism, an alarm mechanism, a virtual lockbox, a central server and database, and a display protector.

While the invention has been illustrated and described in detail in the drawings and foregoing description, the same is to be considered as illustrative and not restrictive in character, it being understood that only the preferred embodiments have been shown and described and that all changes, equivalents, and modifications that come within the spirit of the inventions defined by following claims are desired to be protected.

Accordingly, features of the disclosed embodiments may be combined or arranged for achieving particular advantages as would be understood from the disclosure by one of ordinary skill in the art. Similarly, features of the disclosed embodiments may provide independent benefits applicable to other examples not detailed herein.

Not necessarily all such objects or advantages may be achieved under any embodiment of the disclosure. Those skilled in the art will recognize that the disclosure may be embodied or carried out to achieve or optimize one advantage or group of advantages as taught without achieving other objects or advantages as taught or suggested.

The skilled artisan will recognize the interchangeability of various components from different embodiments described. Besides the variations described, other known equivalents for each feature can be mixed and matched by one of ordinary skill in this art to remote security solution under principles of the present disclosure. Therefore, the embodiments described may be adapted to security solutions for any context, including on-site and office settings, hotels/motels, domestic or international travel, mobile homes, and etc.

Although the remote security system and method has been disclosed in certain preferred embodiments and examples, it therefore will be understood by those skilled in the art that the present disclosure extends beyond the disclosed embodiments to other alternative embodiments and/or uses of the remote security system and obvious modifications and equivalents. It is intended that the scope of the present remote security system disclosed should not be limited by the disclosed embodiments described above, but should be determined only by a fair reading of the claims that follow.

1. A computing system for monitoring a secure workspace, the computing system comprising:
one or more processors, the one or more processors instantiating an Artificial Intelligence (AI) module;
one or more computer-readable storage devices having stored thereon computer-executable instructions that are structured such that, when executed by the one or more processors, cause the computing system to perform the following:
receive one or more video inputs from one or more image capture devices that are located in a secured workspace;
analyze, by the AI module, the received one or more video inputs;
based on the analysis, determine if an unauthorized occupant or unauthorized object is located in the secured workspace or if an unauthorized activity is being performed in the secured workspace;
generate one or more event notifications when it is determined that the unauthorized occupant or the unauthorized object is located in the secured workspace or that the unauthorized activity is being performed in the secured workspace; and
take one or more actions to increase the security of the secured workspace.

2. The computing system of claim 1, the executable instructions being further structured to cause the computing system to perform the following:
receive one or more sensor inputs from one or more sensor devices that are located in the secured workspace; and
analyze, by the AI module, the received sensor inputs, the analyzed sensor inputs being used in the determination of if the unauthorized occupant or the unauthorized object is located in the secured workspace or if the unauthorized activity is being performed in the secured workspace.

3. The computing system of claim 1, wherein the computing system includes a device that is configured to receive the one or more sensor inputs or to transmit one or more signals to the one or more sensor devices.

4. The computing system of claim 1, wherein the analysis performed by the AI module comprises analysis using one or more of an object detection model class, an identity detection model class, an activity detection model class, or a privacy protection model class, wherein each model class comprises one or more models.

5. The computing system of claim 4, wherein the activity detection model class or the identity detection model class comprises a human pose estimation model, the human pose estimation model determining if the unauthorized occupant is located in the secure workspace or if the unauthorized activity is being performed in the secured workspace.

6. The computing system of claim 5, wherein the human pose estimation model comprises key point or key area tracking that at least determines a number of occupants of the secured workspace or determines an activity of an occupant or object in the secured workspace.

7. The computing system of claim 4, wherein the object detection model class comprises an object detection model, the object detection model determining if the unauthorized object is located in the secure workspace.

8. The computing system of claim 4, wherein the identity detection model class comprises a facial recognition model.

9. The computing system of claim 4, wherein the privacy protection model class comprises a privacy protection model that identifies a body part of an occupant of the secured workspace for blurring or pixilation or a privacy protection model that identifies an object or a part of an object in the secured workspace for blurring or pixilation.

10. The computing system of claim 1, wherein the analysis performed by the AI module comprises rendering the received one or more video inputs into one or more of a raw video output, an AI overlay video output, an AI-only video output, or a privacy protection video output, the rendered one or more of the raw video output, the AI overlay video output, the AI-only video output, and privacy protection video output being included as part of the one or more event notifications, the privacy protection video output being determined by one or more privacy protection models.

11. The computing system of claim 10, wherein the AI module determines which of the raw video output, the AI overlay video output, the AI-only video output, and the privacy protection video output to include in the one or more event notifications based on one or more legal requirements relating to privacy and security of information particular to a geographic location.

12. The computing system of claim 9, wherein the one or more event notifications are provided to a remote client computing system, the remote client computing system being configured to further analyze the one or more event notifications to confirm if the unauthorized occupant or the unauthorized object is located in the secured workspace or if the unauthorized activity is being performed in the secured workspace.

13. The computing system of claim 1, wherein the analysis performed by the AI module comprises determining if the one or more image capture devices have been tampered with.

14. The computing system of claim 1, wherein the one or more event notifications are provided to a remote client computing system, the remote client computing system being configured to provide instructions to the computing system in response to receiving the one or more event notifications, the instructions specifying the one or more actions to increase the security of the secured workspace.

15. The computing system of claim 1, wherein the one or more one or more actions to increase the security of the secured workspace are taken in response to the AI module determining that the that the unauthorized occupant or the unauthorized object is located in the secured workspace or that the unauthorized activity is being performed in the secured workspace.

16. The computing system of claim 1, wherein the wherein the one or more one or more actions to increase the security of the secured workspace comprises deactivating one or more computing systems located in the secured workspace or disabling network access to the one or more computing systems located in the secured workspace.

17. The computing system of claim 1, wherein the wherein the one or more one or more actions to increase the security of the secured workspace comprises locking a door of the secured workspace so that the secure workspace is no longer accessible.

18. The computing system of claim 1, wherein the wherein the one or more one or more actions to increase the security of the secured workspace comprises sounding an alarm.

19. A method for monitoring a secure workspace, the method comprising:
receiving one or more video inputs from one or more image capture devices that are located in a secured workspace;
analyzing, by an AI module, the received one or more video inputs;
based on the analysis, determining if an unauthorized occupant or unauthorized object is located in the secured workspace or if an unauthorized activity is being performed in the secured workspace;
generating one or more event notifications when it is determined that the unauthorized occupant or the unauthorized object is located in the secured workspace or that the unauthorized activity is being performed in the secured workspace; and
taking one or more actions to increase the security of the secured workspace.

20. One or more computer-readable storage devices having stored thereon computer-executable instructions that are structured to cause a computing system to perform the following:
receive one or more video inputs from one or more image capture devices that are located in a secured workspace;
analyze, by an AI module, the received one or more video inputs;
based on the analysis, determine if an unauthorized occupant or unauthorized object is located in the secured workspace or if an unauthorized activity is being performed in the secured workspace;
generate one or more event notifications when it is determined that the unauthorized occupant or the unauthorized object is located in the secured workspace or that the unauthorized activity is being performed in the secured workspace; and
take one or more actions to increase the security of the secured workspace.
